(19) United States
(12) Patent Application Publication
(10) Pub. No.: US 2023/0101247 A1
(43) Pub. Date: Mar. 30, 2023

(54) System and Method for Identifying a Remote Device

(71) Applicants: Northeastern University, Boston, MA (US); Università degli Studi di Padova, Padova PD (IT)

(72) Inventors: Francesco Restuccia, Boston, MA (US); Francesca Meneghello, Arcole VR (IT); Michele Rossi, Ferrara FE (IT)

(21) Appl. No.: 17/934,802

(22) Filed: Sep. 23, 2022

Related U.S. Application Data
(60) Provisional application No. 63/261,655, filed on Sep. 24, 2021.

(51) Int. Cl. H04W 12/06; H04B 7/06; H04W 12/71

(52) U.S. Cl. CPC H04W 12/06; H04B 7/0626; H04B 7/0634; H04W 12/71; H04B 7/0452

(57) ABSTRACT

A system and corresponding method identify a remote device. The system comprises a transceiver and a classifier. The transceiver captures a channel state information (CSI) packet that is sent from a receiver device in response to receiving a calibration packet. The calibration packet is sent by the remote device via transmitter hardware. The classifier extracts a feature set from the CSI packet captured. The feature set is affected by characteristics of the transmitter hardware. The classifier produces a classified feature set by classifying the feature set extracted. The classifier further determines an identifier based on the classified feature set. The identifier corresponds to the remote device. The system enables the remote device to be fingerprinted via the identifier and without the need for software-defined radio (SDR) capabilities. As such, the system can be any low-cost Wi-Fi device, such as a laptop.

### RELATED APPLICATION

This application claims the benefit of U.S. Provisional Application No. 63/261,655, filed on Sep. 24, 2021. The entire teachings of the above application are incorporated herein by reference.

### BACKGROUND

Prior to the development of the 802.11n standard, nearly all access points (APs) on the market used antennas with static radiation patterns. APs with internal antennas were almost invariably omnidirectional, while external antennas came in a variety of different radiation patterns. Network designers could choose to use antennas with longer range and narrower beam widths; however, once the antenna was selected, its coverage area was set. Beamforming uses antenna arrays to dynamically alter the transmission pattern of the access point (AP), and the transmission pattern can be changed on a per-frame basis.

Beamforming depends on channel calibration procedures, called “channel sounding” in the 802.11ac standard, to determine how to radiate energy in a preferred direction. Many factors may influence how to steer a beam in a particular direction. For example, within the multi-carrier orthogonal frequency-division multiplexing (OFDM) channel used by 802.11ac, there may be a strong frequency-dependent response that requires limiting data rates over the channel. Alternatively, between two 802.11ac devices, a particular frequency may respond stronger to one path than another. Beamforming enables the endpoints at either side of a link to get maximum performance by taking advantage of channels that have strong performance, while avoiding paths and carriers that have weak performance.

Mathematically, the ability to steer energy may be represented by a steering matrix, which is given the letter Q in 802.11ac. Matrices are used to represent steering information because they are an excellent tool for representing the frequency response from each transmission chain in an array over each transmission stream. Matrix operations allow a spatial mapper to alter the signal to be transmitted for each OFDM subcarrier over each path to the receiver in one operation.

To determine how to radiate energy via channel sounding, the beamformer begins the process by transmitting a Null Data Packet (NDP) announcement frame, which is used to gain control of the channel and identify beamformees. Beamformees will respond to the NDP announcement, while all other stations may simply defer channel access until the sounding sequence is complete.

The beamformer follows the NDP announcement with a NDP. The value of a NDP is that the receiver can analyze the OFDM training fields to calculate the channel response and, therefore, the steering matrix. For multi-user transmissions, multiple null data packets (NDPs) may be transmitted. The beamformee analyzes the training fields in the received NDP and calculates a feedback matrix. The feedback matrix, referred to by the letter V in the 802.11ac specification, enables the beamformer to calculate the steering matrix. The beamformer receives the feedback matrix and calculates the steering matrix to direct transmissions toward the beamformee. With the steering matrix in hand, the beamformer can then transmit frames biased in a particular direction toward the beamformee.

### SUMMARY

According to an example embodiment, a method for identifying a remote device comprises capturing a channel state information (CSI) packet, sent from a receiver device in response to receiving a calibration packet. The calibration packet is sent by the remote device via transmitter hardware. The method further comprises extracting a feature set from the CSI packet captured. The feature set is affected by characteristics of the transmitter hardware. The method further comprises producing a classified feature set by classifying the feature set extracted. The method further comprises determining an identifier based on the classified feature set. The identifier corresponds to the remote device.

The CSI packet may be a non-encrypted packet. The CSI packet may be a multi-user multi-input, multi-output (MU-MIMO) CSI packet.

The characteristics may represent at least one imperfection of the transmitter hardware of the remote device.

The remote device may be among a plurality of remote devices. The identifier determined may include a) a unique device identifier, the unique device identifier distinguishing the remote device from the plurality of remote devices and b) a probability that the remote device sent the CSI packet.

The calibration packet may be sent from a beamformer to a beamformee. The CSI packet may represent beamforming feedback information. The method may further comprise capturing the CSI packet by monitoring a wireless channel between the beamformer and the beamformee.

The feature set extracted may include beamforming feedback matrices computed by the beamformee. The classifying may be based on beamforming feedback angles. The beamforming feedback angles may be derived from the beamforming feedback matrices.

The classifying may include employing a machine learning model to produce the classified feature set.

The CSI packet may include physical layer (PHY) level information. The classifying may include demodulating the PHY-level information and processing, via the machine learning model, the PHY-level information demodulated.

The remote device may be wireless device. The wireless device may be Wi-Fi compliant.

The method may further comprise employing the identifier to authenticate the remote device or outputting the identifier to a system. The system may be configured to authenticate the remote device based on the identifier output.

According to another example embodiment, a system for identifying a remote device comprises a transceiver and a classifier. The transceiver is configured to capture a channel state information (CSI) packet, sent from a receiver device in response to receiving a calibration packet. The calibration packet is sent by the remote device via transmitter hardware. The classifier is configured to extract a feature set from the CSI packet captured. The feature set is affected by characteristics of the transmitter hardware. The classifier is further configured to produce a classified feature set by classifying the feature set extracted. The classifier is further configured to determine an identifier based on the classified feature set. The identifier corresponds to the remote device.

Alternative system embodiments parallel those described above in connection with the example method embodiment.

According to another example embodiment, a non-transitory computer-readable medium for identifying a remote device has encoded thereon a sequence of instructions which, when loaded and executed by at least one processor, causes the at least one processor to capture a channel state information (CSI) packet, sent from a receiver device in response to receiving a calibration packet. The calibration packet is sent by the remote device via transmitter hardware. The sequence of instructions further causes the at least one processor to extract a feature set from the CSI packet captured. The feature set is affected by characteristics of the transmitter hardware. The sequence of instructions further causes the at least one processor to produce a classified feature set by classifying the feature set extracted. The sequence of instructions further causes the at least one processor to determine an identifier based on the classified feature set. The identifier corresponds to the remote device.

Alternative non-transitory computer-readable medium embodiments parallel those described above in connection with the example method embodiment.

It should be understood that example embodiments disclosed herein can be implemented in any combination and in the form of a method, apparatus, system, or non-transitory computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is block diagram of an example embodiment of a computing environment that includes an example embodiment of a system for identifying a remote device.

FIG. 2 is flow diagram of an example embodiment of a method for identifying a remote device.

FIG. 3 is block diagram of another example embodiment of a computing environment that includes an example embodiment of a system for identifying a remote device.

FIG. 4 is block diagram of an example embodiment of a 3×2 multi-input, multi-output (MIMO) system.

FIG. 5 is a table with an example embodiment of a method for Vₖ matrix decomposition.

FIG. 6 is a bounce diagram of an example embodiment of DeepCSI workflow.

FIG. 7 is a block diagram of an example embodiment of a DeepCSI learning method.

FIG. 8 is an image of an example embodiment of a beamformer.

FIG. 9 is a schematic diagram of an example embodiment of an indoor environment configuration.

FIG. 10A is a table that summarizes an example embodiment of different training/testing sets for dataset D1.

FIG. 10B is a table that summarizes an example embodiment of different training/testing sets for dataset D2.

FIG. 11A is a plot of an example embodiment of DeepCSI accuracy by varying the number of convolutional layers, with 128 filters each, from 2 to 7.

FIG. 11B is a plot of an example embodiment of DeepCSI accuracy by using 5 convolutional layers and varying the number of filters in each layer, from 16 to 256.

FIGS. 12A-C are plots of example embodiments of confusion matrices for beamformee 1, 3 TX antennas, and spatial stream 0.

FIGS. 13A-C are plots of example embodiments of confusion matrices for mixed beamformees, 3 TX antennas, and spatial stream 0.

FIG. 14 is a chart of an example embodiment of DeepCSI accuracy by varying the number of training positions from the considered set.

FIGS. 15A and 15B are plots of example embodiments of confusion matrices for set S1, training on one beamformee and testing on the other, with 3 TX antennas and spatial stream 0.

FIG. 16A is a chart of an example embodiment of DeepCSI accuracy obtained by varying the channel bandwidth.

FIG. 16B is a chart of an example embodiment of DeepCSI accuracy by varying the number of transmitter antennas.

FIGS. 17A and 17B are plots of example embodiments of the probability density function (PDF) of the \tilde{V} quantization error.

FIGS. 18A-F are plots of example embodiments of time evolution of \tilde{V}.

FIGS. 19A-C are plots of example embodiments of confusion matrices with beamformee 1, 3 TX antennas, and spatial stream 1.

FIG. 20A is a chart of an example embodiment of DeepCSI accuracy compared with one obtained using processed input.

FIG. 20B is a plot of an example embodiment of a confusion matrix for S1 after offset correction.

FIGS. 21A-D are example embodiments of plots of confusion matrices with beamformee 1, 3 TX antennas, and spatial stream 0.

FIG. 22 is a block diagram of an example of the internal structure of a computer in which various embodiments of the present disclosure may be implemented.

### DETAILED DESCRIPTION

A description of example embodiments follows.

While an example embodiment disclosed herein may be described with reference to Wi-Fi (WiFi), it should be understood that such embodiment is not limited to Wi-Fi as a wireless technology. Further, it should be understood that a wireless transmitter and wireless receiver disclosed herein is not limited to functioning as a wireless transmitter and wireless receiver, respectively, as such wireless devices may be wireless transceivers.

### I. Overview and Example Embodiments

The sheer expansion of Internet of Things (IoT) is rapidly saturating unlicensed spectrum bands (Federal Communications Commission (FCC), “Spectrum Crunch,” https://www.nist.gov/advanced-communications/spectrum-crunch). With the global mobile data traffic projected to reach 164 exabytes per month in 2025 (Ericsson Incorporated, “Ericsson Interim Mobility Report, June 2020,” https://www.ericsson.com/49da93/assets/local/mobility-report/documents/2020/june2020-ericsson-mobility-report.pdf, 2020), spectrum congestion will soon decrease data throughput to intolerable levels. To alleviate the issue, the Federal Communication Commission (FCC) released 150 MHz additional bandwidth in the 3.5 GHz spectrum band (Jamie Davies, Telecoms.com, “FCC finally opens up 3.5 GHz for US telcos,” https://telecoms.com/502070/fcc-finally-opens-up-3-5-ghz-for-us-telcos/, 2020), as well as 1.2 GHz in the 6 GHz band (5.925-7.125), the latter providing opportunities to use up to 320 MHz channels to expand capacity and increase network performance Federal Communications Commission (FCC), “FCC Opens 6 GHz Band to Wi-Fi and Other Unlicensed Uses,” https://www.fcc.gov/document/fcc-opens-6-ghz-band-wi-fi-and-other-unlicensed-uses, 2020).

The release of these spectrum bands for unlicensed use implies that previously licensed users (also known as incumbents), unlicensed Wi-Fi devices (Wi-Fi Alliance, “Wi-Fi 6E expands Wi-Fi into 6 GHz,” https://www.wi-fi.org/file/wi-fi-6e-highlights, 2021) and 5G cellular networks (GSMA.com, “Capacity to Power Innovation: 5G in the 6 GHz Band,” https://tinyurl.com/5G-6GHz-Bands, 2021) will need to coexist in the same spectrum bands. This will necessarily require the enactment of strict, fine-grained dynamic spectrum access (DSA) rules (J. Horwitz, V. Beat, “Wi-Fi 6E and 5G Will Share 6 GHz Spectrum to Supercharge Wireless Data,” https://tinyurl.com/wyvmn5c, 2020), which will require spectrum administrators to continuously monitor which unlicensed Wi-Fi device is using the spectrum, and when the device is using it. To this end, cryptography-based techniques are substantially unfeasible in this context, since a spectrum observer should possess the private keys exchanged among all the nodes in the network, which is unrealistic.

On the other hand, radio fingerprinting (RFP) has attracted significant attention as reliable and effective spectrum-level authentication technique (T. Zheng, Z. Sun, and K. Ren, “FID: Function Modeling-based Data-Independent and Channel-Robust Physical-Layer Identification,” in Proc. of IEEE INFOCOM, 2019, L. Peng, A. Hu, J. Zhang, Y. Jiang, J. Yu, and Y. Yan, “Design of a Hybrid RF Fingerprint Extraction and Device Classification Scheme,” IEEE Internet of Things Journal, vol. 6, no. 1, pp. 349-360, 2019, F. Xie, H. Wen, Y. Li, S. Chen, L. Hu, Y. Chen, and H. Song, “Optimized Coherent Integration-Based Radio Frequency Fingerprinting in Internet of Things,” IEEE Internet of Things Journal, vol. 5, no. 5, pp. 3967-3977, 2018, Y. Xing, A. Hu, J. Zhang, L. Peng, and G. Li, “On Radio Frequency Fingerprint Identification for DSSS Systems in Low SNR Scenarios,” IEEE Communications Letters, vol. 22, no. 11, pp. 2326-2329, 2018, K. Sankhe, M. Belgiovine, F. Zhou, S. Riyaz, S. Ioannidis, and K. Chowdhury, “ORACLE: Optimized Radio classification through Convolutional neural networks,” in Proc. of IEEE INFOCOM, 2019, T. D. Vo-Huu, T. D. Vo-Huu, and G. Noubir, “Fingerprinting Wi-Fi Devices Using Software Defined Radios,” in Proc. of ACM WiSec, 2016, A. Al-Shawabka, F. Restuccia, S. D'Oro, T. Jian, B. C. Rendon, N. Soltani, J. Dy, S. Ioannidis, K. Chowdhury, and T. Melodia, “Exposing the Fingerprint: Dissecting the Impact of the Wireless Channel on Radio Fingerprinting,” in Proc. of IEEE INFOCOM, 2020). RFP leverages naturally-occurring circuitry imperfections to compute a unique “fingerprint” of the device directly at the waveform level (E. Johnson, “Physical Limitations on Frequency and Power Parameters of Transistors,” in Proc. of IRE International Convention Record, 1966). Although RFP for physical layer (PHY) Wi-Fi authentication has been explored, existing approaches require software-defined radio (SDR) devices to extract RFP features. This may ultimately prevent widespread adoption, since SDRs require expert knowledge and are usually more expensive than off-the-shelf devices.

Moreover, existing work has tackled Wi-Fi fingerprinting up to the legacy 802.11a/g/b standards, which do not support multi-input, multi-output (MIMO) techniques. Newer Wi-Fi releases, such as 802.11ac/ax and the upcoming 802.11be, will heavily rely on multi-user MIMO (MU-MIMO) techniques to deliver significantly higher throughput than previous standards (E. H. Ong, J. Kneckt, O. Alanen, Z. Chang, T. Huovinen, and T. Nihtild, “IEEE 802.11ac: Enhancements for very high throughput WLANs,” in Proc. of IEEE PIMRC, 2011, E. Khorov, A. Kiryanov, A. Lyakhov, and G. Bianchi, “A tutorial on IEEE 802.11ax high efficiency WLANs, IEEE Communications Surveys & Tutorials,” vol. 21, no. 1, pp. 197-216, 2018, C. Deng, X. Fang, X. Han, X. Wang, L. Yan, R. He, Y. Long, and Y. Guo, “IEEE 802.11be Wi-Fi 7: New challenges and opportunities,” IEEE Communications Surveys & Tutorials, vol. 22, no. 4, pp. 2136-2166, 2020). Thus, it is still unknown whether existing RFP strategies can be applied in the significantly more complex MU-MIMO scenario, where inter-user interference (IUI) and inter-stream interference (ISI) can significant decrease the quality of the fingerprint itself.

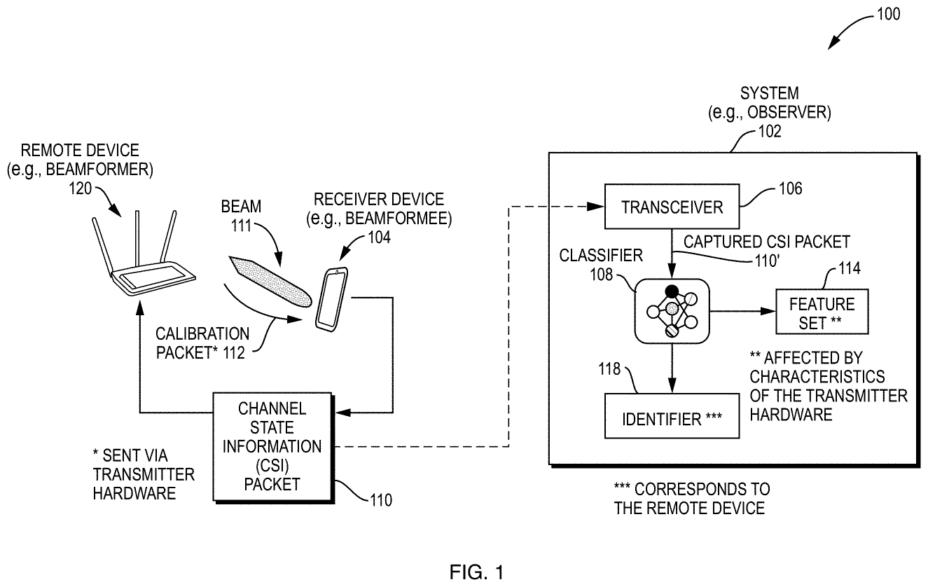

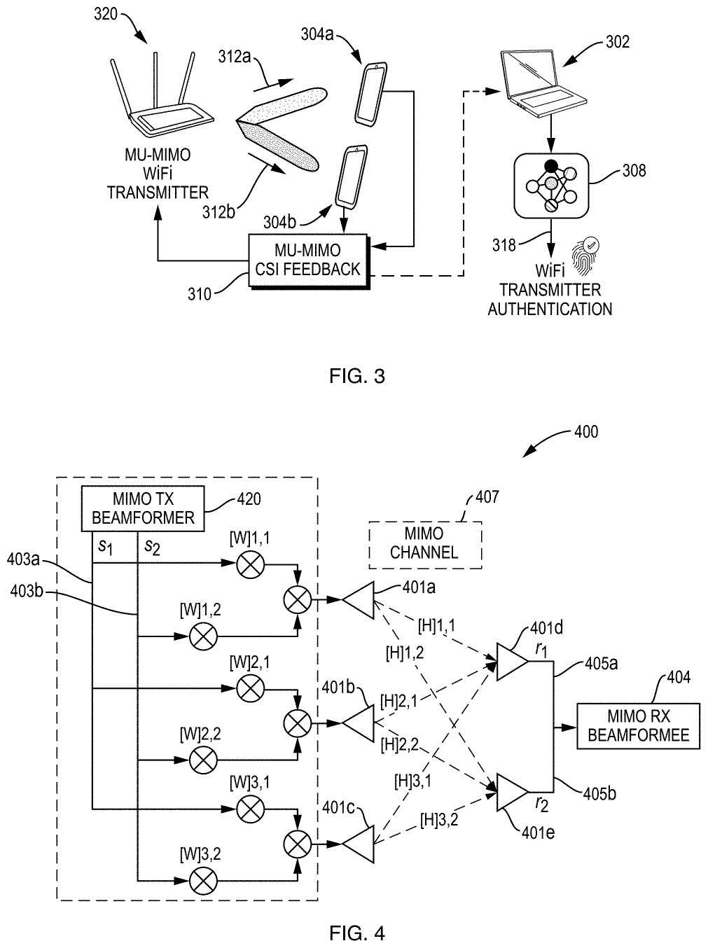

To fill such research gap, an example embodiment employs DeepCSI, a brand-new technique for RFP of Wi-Fi devices, summarized with regard to FIGS. 1-3, further below. The core intuition behind DeepCSI is that the circuitry imperfections in the transmitter's radio interface will percolate onto the MU-MIMO channel state information (CSI) feedback sent by the receiver to the transmitter to perform beamforming. By demodulating this PHY-level information and performing deep learning techniques on a processed version of the feedback, an observer, such as the system 102 and system 103 or FIG. 1 and FIG. 3, respectively, can fingerprint the transmitter without the need of SDR capabilities. Note that the observer can leverage the feedback from any beamformee associated with the target beamformer to compute the beamformer's fingerprint. An advantage of an example embodiment of a technique disclosed herein is that such technique is not affected by ISI nor by IUI—as disclosed further below in Section II-A. The effect of IUI and ISI may prevent the correct devices' authentication. Previous work only considered non-MIMO transmissions where IUP/ISI are not present and, in turn, the plain CSI information suffices to perform RFP. On the other hand, the core concern of performing RFP without direct CSI access is that it is unknown whether the imperfections will actually percolate onto the beamforming feedback matrix. In this context, it is useful to evaluate the PHY fingerprinting techniques as a function of different channels and different transmitter-receiver positions, since these can significantly undermine the fingerprint (A. Al-Shawabka, F. Restuccia, S. D'Oro, T. Jian, B. C. Rendon, N. Soltani, J. Dy, S. Ioannidis, K. Chowdhury, and T. Melodia, “Exposing the Fingerprint: Dissecting the Impact of the Wireless Channel on Radio Fingerprinting,” in Proc. of IEEE INFOCOM, 2020).

In an example embodiment of DeepCSI disclosed herein, the first approach is to perform RFP of MU-MIMO Wi-Fi devices. DeepCSI uses deep learning of the standard-compliant beamforming matrices to learn the device-unique imperfections located in the CSI and authenticate MU-MIMO Wi-Fi devices directly at the PHY layer. The core intuition is that imperfections in the transmitter's radio circuitry are also present in the beamforming feedback matrix that is transmitted in clear text. Thus, conversely from prior work, explicit CSI computation through SDR technologies are not needed and DeepCSI can be run on any low-cost Wi-Fi device. Through DeepCSI, an observer can leverage the beamforming feedback matrix from any beamformee—one at a time—associated with the beamformer to be authenticated. Given the small memory footprint, the trained learning method can be run to perform the online inference on low-cost Wi-Fi devices, e.g., laptops, without the need for powerful facilities.

The performance of DeepCSI is evaluated, as disclosed further below, through a massive data collection campaign performed in the wild with off-the-shelf equipment, where 10 Wi-Fi radios emit MU-MIMO signals to multiple receivers located at different positions (and thus, with different beam patterns). Experimental results indicate that DeepCSI is able to correctly identify the transmitter with an accuracy above 98%, which shows that RFP of MU-MIMO devices can be performed leveraging the CSI beamforming feedback matrices. The impact of the feedback quantization error is evaluated on the performance—where quantization is applied for transmission efficiency reasons as per the Wi-Fi standards (IEEE, “IEEE Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11-2012), 2013, “IEEE Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications Amendment 1: Enhancements for High-Efficiency WLAN,” IEEE Std 802.11ax-2021 (Amendment to IEEE Std 802.11-2020), 2021)—observing an accuracy increase of up to 63% when changing the feedback PHY parameters. As disclosed herein, DeepCSI achieves at least 17% more accuracy than methods based on CSI phase cleaning, since the latter partially remove the imperfections due to the hardware circuitry. Further, the beamformer identification accuracy is evaluated “on the move,” where DeepCSI achieves an accuracy above 82%. A system that employs an example embodiment of DeepCSI is disclosed below with regard to FIG. 1.

FIG. 1 is block diagram of an example embodiment of a computing environment 100 that includes an example embodiment of a system 102 for identifying a remote device 120. It should be understood that the computing environment 100 is not limited to the elements shown in FIG. 1. The system 102 comprises a transceiver 106 and a classifier 108. The transceiver 106 is configured to capture a channel state information (CSI) packet 110, sent from a receiver device 120 in response to receiving a calibration packet 112. The calibration packet is sent by the remote device 120 via transmitter hardware (not shown). The classifier 108 is configured to extract a feature set 114 from the CSI packet 110 captured, namely the captured CSI packet 110′. The feature set 114 is affected by characteristics (not shown) of the transmitter hardware. The classifier 108 is further configured to produce a classified feature set (not shown) by classifying the feature set 114 extracted. The classifier 108 is further configured to determine an identifier 118 based on the classified feature set. The identifier 118 corresponds to the remote device 120.

Such actions performed by the transceiver 106 and classifier 108 of the system 102 may represent an example embodiment of DeepCSI disclosed herein. The remote device 120 may be a wireless device that is Wi-Fi compliant. In the example embodiment of the FIG. 1, the calibration packet 112 is sent via a wireless channel (not shown). The calibration packet 112 may be a null data packet (NDP) packet disclosed herein. The CSI packet 110 may be a non-encrypted (clear) packet. According to an example embodiment, the CSI packet 110 may be a multi-user multi-input, multi-output (MU-MIMO) CSI packet.

The remote device 120 may be among a plurality of remote devices (not shown). The identifier 118 determined may include a unique device identifier (not shown). The unique device identifier may distinguish the remote device 120 from the plurality of remote devices. The unique device identifier may further include a probability (not shown) that it was the remote device 120 that sent the CSI packet 110. The identifier 118 may be referred to as a radio fingerprint or, simply, a fingerprint.

The remote device 120 may be a beamformer and the receiver device 104 may be a beamformee. As such, the calibration packet 112 may be sent from a beamformer to a beamformee for sounding a channel in order to direct a beam 111 toward the beamformee as is known in the art. The CSI packet 110 may represent beamforming feedback information disclosed herein. The transceiver 106 may be further configured to capture the CSI packet 110 by monitoring a wireless channel (not shown) between the beamformer and the beamformee, namely the remote device 120 and receiving device 104, respectively, in the example embodiment.

As disclosed above, the classifier 108 is configured to extract a feature set 114 from the CSI packet 110 captured and may be affected by characteristics of the transmitter hardware. Such characteristics may include at least one imperfection of the transmitter hardware of the remote device 120. The feature set 114 extracted may include beamforming feedback matrices (not shown) computed by the beamformee, namely the receiving device 104, and values of such feedback matrices may be affected by the at least one imperfection. Such beamforming feedback matrices are disclosed further below. The classifying performed by the classifier 108 may be based on beamforming feedback angles (not shown), as disclosed further below. The beamforming feedback angles may be derived from the beamforming feedback matrices.

The classifier 108 may be further configured to employ a machine learning model (not shown) to produce the classified feature set. The CSI packet 110 may include physical layer (PHY) level information (not shown). The classifier 108 may be further configured to demodulate the PHY-level information and process, via the machine learning model, the PHY-level information demodulated, as disclosed further below.

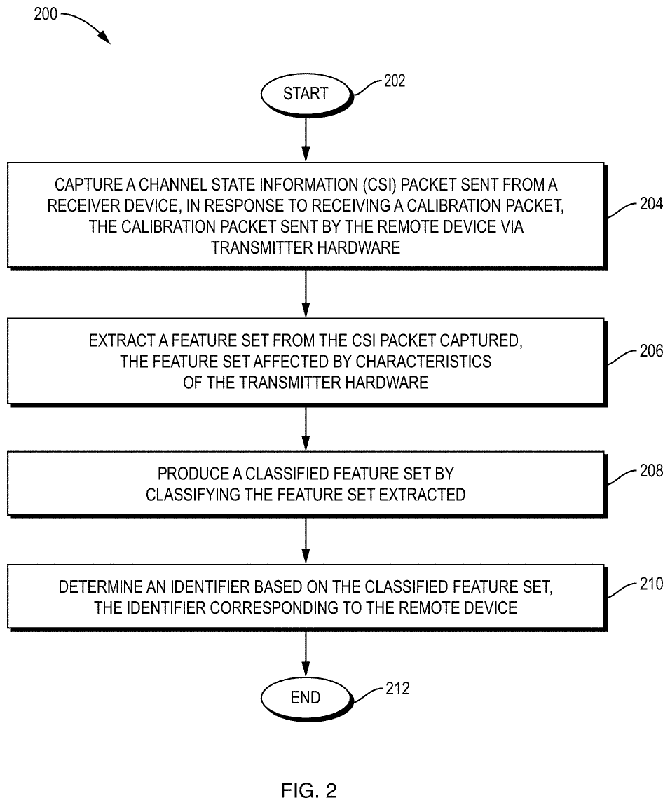

According to an example embodiment, the system 102 may further comprise a controller (not shown). The controller may be configured to employ the identifier 118 to authenticate the remote device 120 or output the identifier 118 to an other system (not shown). The other system may be configured to authenticate the remote device 120 based on the identifier 118 output. According to an example embodiment, the identifier 118 may be employed for spectral management to exclude or find a device that is not obeying bandwidth rules, to block an unauthorized device, or to give an authorized device allowance for traffic for non-limiting examples. An example embodiment of a method that may determine the identifier 118 is disclosed below with regard to FIG. 2.

FIG. 2 is flow diagram of an example embodiment of a method (200) for identifying a remote device. The method begins (202) and comprises capturing a channel state information (CSI) packet, sent from a receiver device in response to receiving a calibration packet, the calibration packet sent by the remote device via transmitter hardware. The method further comprises extracting a feature set from the CSI packet captured, the feature set affected by characteristics of the transmitter hardware (206). The method further comprises producing a classified feature set by classifying the feature set extracted (208). The method further comprises determining an identifier based on the classified feature set, the identifier corresponding to the remote device (210). The method thereafter ends (212) in the example embodiment.

FIG. 3 is block diagram of another example embodiment of a computing environment 100 that includes an example embodiment of a system 302 for identifying a remote device 320. In the example embodiment of FIG. 3, the remote device 320 is a MU-MIMO Wi-Fi transmitter and may be referred to as a beamformer. The system 302 comprises a transceiver (not shown) and, in the example embodiment the system 302 is a laptop for non-limiting example. The system 302 further comprises a classifier 308. The transceiver is configured to capture a channel state information (CSI) packet 310, sent from a receiver device 304a or receiver device 304b in response to receiving a calibration packet 312a or 312b, respectively. The calibration packet (312a, 312b) is sent by the remote device 120 via transmitter hardware (not shown). In the example embodiment of FIG. 3, the CSI packet 310 is MU-MIMO CSI feedback packet. The classifier 308 is configured to extract a feature set (not shown) from the CSI packet 310 captured. The feature set is affected by characteristics (not shown) of the transmitter hardware. The classifier 308 is further configured to produce a classified feature set (not shown) by classifying the feature set extracted. The classifier 308 is further configured to determine an identifier 318 based on the classified feature set. The identifier 318 corresponds to the remote device 320 and may be used by the system 302 or another system (not shown) to perform Wi-Fi transmitter authentication. In the example embodiment of FIG. 3, the beamformer's fingerprint, that is, the identifier 318 of the remote device 320 can be independently extracted from the feedback of any beamformee (304a, 304b). Further details and embodiments are disclosed below.

### II. Further Overview and Challenges

Thanks to their capability of identifying transmitters without the need of computation-hungry cryptography techniques, RFP techniques have received a significant amount of attention from the research community (L. Peng, A. Hu, J. Zhang, Y. Jiang, J. Yu, and Y. Yan, “Design of a Hybrid RF Fingerprint Extraction and Device Classification Scheme,” IEEE Internet of Things Journal, vol. 6, no. 1, pp. 349-360, 2019, F. Xie, H. Wen, Y. Li, S. Chen, L. Hu, Y. Chen, and H. Song, “Optimized Coherent Integration-Based Radio Frequency Fingerprinting in Internet of Things,” IEEE Internet of Things Journal, vol. 5, no. 5, pp. 3967-3977, 2018, Y. Xing, A. Hu, J. Zhang, L. Peng, and G. Li, “On Radio Frequency Fingerprint Identification for DSSS Systems in Low SNR Scenarios,” IEEE Communications Letters, vol. 22, no. 11, pp. 2326-2329, 2018, T. D. Vo-Huu, T. D. Vo-Huu, and G. Noubir, “Fingerprinting Wi-Fi Devices Using Software Defined Radios,” in Proc. of ACM WiSec, 2016, Q. Xu, R. Zheng, W. Saad, and Z. Han, “Device Fingerprinting in Wire-less Networks: Challenges and Opportunities,” IEEE Communications Surveys & Tutorials, vol. 18, no. 1, pp. 94-104, 2016). While early work has demonstrated the feasibility of RFP, it has focused on the extraction of complex hand-tailored features, which do not scale well with the device population, or work in ad hoc propagation settings only. Among the first works on Wi-Fi-specific RFP, Vo et al. (T. D. Vo-Huu, T. D. Vo-Huu, and G. Noubir, “Fingerprinting Wi-Fi Devices Using Software Defined Radios,” in Proc. of ACM WiSec, 2016) propose RFP techniques that extract features from the scrambling seed, the level of frequency offset and transients between symbols. However, the models achieve accuracy up to 50% on 100 devices. The authors in (L. Peng, A. Hu, J. Zhang, Y. Jiang, J. Yu, and Y. Yan, “Design of a Hybrid RF Fingerprint Extraction and Device Classification Scheme,” IEEE Internet of Things Journal, vol. 6, no. 1, pp. 349-360, 2019), instead, demonstrated that up to 54 ZigBee devices can be fingerprinted with about 95% accuracy through PSK transients. More recently, Zheng et al. (T. Zheng, Z. Sun, and K. Ren, “FID: Function Modeling-based Data-Independent and Channel-Robust Physical-Layer Identification,” in Proc. of IEEE INFOCOM, 2019) studied and evaluated in a testbed of 33 devices a model-based approach to summarize imperfections in the modulation, timing, frequency and power amplifier noise. It is not clear, however, whether the approach in (T. Zheng, Z. Sun, and K. Ren, “FID: Function Modeling-based Data-Independent and Channel-Robust Physical-Layer Identification,” in Proc. of IEEE INFOCOM, 2019) generalizes to different channel environments.

In stark contrast with early work, recent RFP papers have leveraged deep learning techniques to fingerprint wireless devices (K. Sankhe, M. Belgiovine, F. Zhou, S. Riyaz, S. Ioannidis, and K. Chowdhury, “ORACLE: Optimized Radio classification through Convolutional neural networks,” in Proc. of IEEE INFOCOM, 2019, Restuccia, S. D'Oro, A. Al-Shawabka, M. Belgiovine, L. Angioloni, S. Ioannidis, K. Chowdhury, and T. Melodia, “DeepRadioID: Real-Time Channel-Resilient Optimization of Deep Learning-based Radio Fingerprinting Algorithms,” in Proc. of ACM MobiHoc, 2019, S. Riyaz, K. Sankhe, S. Ioannidis, and K. Chowdhury, “Deep Learning Convolutional Neural Networks for Radio Identification,” IEEE Communications Magazine, vol. 56, no. 9, pp. 146-152, 2018, K. Merchant, S. Revay, G. Stantchev, and B. Nousain, “Deep Learning for RF Device Fingerprinting in Cognitive Communication Networks,” IEEE Journal of Selected Topics in Signal Processing, vol. 12, no. 1, pp. 160-167, 2018, R. Das, A. Gadre, S. Zhang, S. Kumar, and J. M. Moura, “A Deep Learning Approach to IoT Authentication,” in Proc. of IEEE ICC, 2018). An advantage of deep learning techniques is that they are able to perform feature extraction and classification at the same time, thus avoiding manual extraction of device-distinguishing features. For example, Das et al. (R. Das, A. Gadre, S. Zhang, S. Kumar, and J. M. Moura, “A Deep Learning Approach to IoT Authentication,” in Proc. of IEEE ICC, 2018) and Merchant et al. (K. Merchant, S. Revay, G. Stantchev, and B. Nousain, “Deep Learning for RF Device Fingerprinting in Cognitive Communication Networks,” IEEE Journal of Selected Topics in Signal Processing, vol. 12, no. 1, pp. 160-167, 2018) deep neural networks (DNNs) achieve more than 90% accuracy with a population of 7 ZigBee devices and 30 LoRa devices. To further increase accuracy, (K. Sankhe, M. Belgiovine, F. Zhou, S. Riyaz, S. Ioannidis, and K. Chowdhury, “ORACLE: Optimized Radio classification through Convolutional neural networks,” in Proc. of IEEE INFOCOM, 2019, Riyaz, K. Sankhe, S. Ioannidis, and K. Chowdhury, “Deep Learning Convolutional Neural Networks for Radio Identification,” IEEE Communications Magazine, vol. 56, no. 9, pp. 146-152, 2018) proposed the introduction of artificial impairments at the transmitter's side. However, without compensation, this approach inevitably increases the bit error rate (BER). The usage of complex-valued convolutional neural networks (CNNs) has been explored by Gopalakrishnan et al. (S. Gopalakrishnan, M. Cekic, and U. Madhow, “Robust Wireless Fingerprinting via Complex-Valued Neural Networks,” in Proc. of IEEE GLOBECOM, 2019), while in (F. Restuccia, S. D'Oro, A. Al-Shawabka, M. Belgiovine, L. Angioloni, S. Ioannidis, K. Chowdhury, and T. Melodia, “DeepRadioID: Real-Time Channel-Resilient Optimization of Deep Learning-based Radio Fingerprinting Algorithms,” in Proc. of ACM MobiHoc, 2019) and (S. D'Oro, F. Restuccia, and T. Melodia, “Can You Fix My Neural Network? Real-Time Adaptive Waveform Synthesis for Resilient Wireless Signal Classification,” in Proc. of IEEE INFOCOM, 2021) the authors propose the usage of finite impulse response (FIR) filters to compensate for the adverse action of the wireless channel on the fingerprinting accuracy. The key limitation of existing work is that it is entirely based on SDRs, which is very specialized, expensive equipment that is not widely available in common Wi-Fi networks. Moreover, as understood, no prior work has tackled the issue of assessing whether RFP is feasible in MU-MIMO Wi-Fi networks. As disclosed herein, both issues are addressed at once by presenting DeepCSI, a framework that (i) can be run on any off-the-shelf Wi-Fi-compliant device, and (ii) can accurately fingerprint MU-MIMO devices. The performance of DeepCSI is evaluated in static and—for the first time—dynamic conditions, assessing the robustness of the learned fingerprint to changing transmission channel characteristics.

### Challenges of MU-MIMO Fingerprinting

Performing RFP of devices operating in downlink (DL) MU-MIMO mode is significantly more challenging than RFP of devices operating with omnidirectional antennas. First, transmissions are inevitably impaired by imperfect beamforming weights that do not accurately compensate the wireless channel. Secondly, (i) inter-stream interference (ISI) occurs between streams transmitted to the same receiver, and (ii) inter-user interference (IUI) affects streams directed to different receivers. The time-varying behavior of both ISI and IUI complicates the identification of the device-specific imperfections. Moreover, it has been shown in prior work that the RFP process may be adversely impacted by the presence of the wireless channel (K. Sankhe, M. Belgiovine, F. Zhou, S. Riyaz, S. Ioannidis, and K. Chowdhury, “ORACLE: Optimized Radio classification through Convolutional neural networks,” in Proc. of IEEE INFOCOM, 2019, A. Al-Shawabka, F. Restuccia, S. D'Oro, T. Jian, B. C. Rendon, N. Soltani, J. Dy, S. Ioannidis, K. Chowdhury, and T. Melodia, “Exposing the Fingerprint: Dissecting the Impact of the Wireless Channel on Radio Fingerprinting,” in Proc. of IEEE INFOCOM, 2020). As such, a different approach for extracting effective radio fingerprints is disclosed herein.

Specifically, an example embodiment may employ the beamforming feedback matrix described in Section III-B. The matrix \tilde{V} is estimated based on the very high throughput (VHT)-long training fields (LTFs) of the null data packet (NDP) that is sent in broadcast mode without being beamformed. Moreover, the VHT-LTFs are sent over the different antennas in subsequent time slots of 4 μs each. Therefore, the NDP and, in turn, \tilde{V}, are not affected by IUI nor by ISI. However, since the feedback matrix is quantized before transmission, quantization errors are inevitable. In Section V, disclosed further below, the effect of the quantization error is analyzed and the generalization capability of an example embodiment of a RFP approach to multiple channels and beamformee positions, and to beamformer's mobility, is investigated.

Henceforth, the following notation for mathematical expressions is adopted. The superscripts T and † respectively denote the transpose and the Hermitian of a matrix, i.e., the complex conjugate transpose. By ∠C, the reference is to the matrix whose elements are the phases of the corresponding elements in the complex-valued matrix C. diag(c₁, . . . , cⱼ) indicates the diagonal matrix with elements (c₁, . . . , cⱼ) on the main diagonal. The (c₁, c₂) entry of matrix C is denoted by [C]c₁,c₂. Finally, I_{c} refers to a c×c identity matrix while I_{c×d} is a c×d matrix with ones on the main diagonal and zeros elsewhere.

### A. Preliminaries on MU-MIMO in Wi-Fi

In the following, Wi-Fi devices operating with the IEEE 802.11ac (Wi-Fi 5) standard and 802.11ax (WiFi 6 and 6E) (IEEE, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11-2012), 2013, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 1: Enhancements for High-Efficiency WLAN,” IEEE Std 802.11ax-2021 (Amendment to IEEE Std 802.11-2020), 2021) are considered. These devices operate on the 2.4 GHz, 5 GHz and 6 GHz frequency bands with channels having up to 160 MHz of bandwidth. In Wi-Fi, data is transmitted via orthogonal frequency-division multiplexing (OFDM) by dividing the selected channel into K partially overlapping and orthogonal sub-channels, spaced apart by 1/T. The input bits are grouped into OFDM samples, aₖ, and symbols, a=[a−K/2, . . . , a_{K}/2−1], collecting K samples each. After being digitally modulated, the K samples of one OFDM symbol are simultaneously transmitted though the K OFDM sub-channels, occupying the channel for T seconds. Up-converted to the carrier f_{c}, the transmitted signal is

$${s}_{tx} ( t ) = {e}^{j 2 π {f}_{c} t} {\sum }_{k = - K / 2}^{K / 2 - 1} {a}_{k} {e}^{j 2 π kt / T} . \qquad ( 1 )$$

To improve the signal-to-noise ratio (SNR), the transmitter can use beamforming to focus the power toward the intended receiver. The beamforming may also compensate the effect of the wireless channel from the transmitter (beamformer) to the receiver (beamformee). When both devices in the communication link are equipped with antenna arrays (MIMO system), each pair of transmitter and receiver antennas forms a physical channel that can be exploited for wireless communication. This spatial diversity allows shaping multiple beams, referred to as spatial streams, to transmit different signals to the beamformee, in a parallel fashion. To this end, the signals are combined at each transmitter antenna through steering weights, W, derived from the channel frequency response (CFR) matrix H. The CFR needs to be estimated for every OFDM sub-channel over each pair of transmitter (TX) and receiver (RX) antennas, thus obtaining a K×M×N matrix, where M and N are respectively the number of TX and RX antennas. In FIG. 4, an example embodiment of beamforming for a 3×2 MIMO system is shown.

FIG. 4 is block diagram of an example embodiment of a 3×2 multi-input, multi-output (MIMO) system 400. In the example embodiment of FIG. 4, the triangles (401a, 401b, 401c, 401d) represent antennas and the MIMO TX beamformer 420 communicates with the MIMO RX beamformee 404 via a MIMO channel 407. The signals s₁, s₂ (401a, 401b)and r₁, r₂ (405a, 405b) are the transmitted and received signals respectively. W is the steering matrix containing the weights to shape the beams. H is the CFR.

At the beamformee side, the original signals are retrieved from their combination exploiting the fact that, ideally, [H [symbol] [W [symbol] =0 when [symbol] ≠ [symbol] or ī≠i.

A meaningful model for the CFR H in indoor spaces is obtained by considering the proprieties of the wireless propagation. After being irradiated by the transmitter antenna m∈{0, . . . M−1}, the signal is reflected by objects in the environment and, in turn, P different copies of sₜₓ(t) are collected at the receiver antenna n∈{0, . . . , N−1}. Each received signal is characterized by an attenuation Aₚ and a delay τₚ that depends on the length of the path followed by the transmitted wave. Thus, the (k, m, n) element of H is

$${[ H ]}_{k , m , n} = {\sum }_{p = 0}^{P - 1} {A}_{m , n , p} {e}^{- j 2 π ( {f}_{c} + k / T ) {τ}_{m , n , p}} . \qquad ( 2 )$$

By knowing H, the beamformer can generate the steering matrix W to maximize the power sent toward the beamformee 404 or simultaneously send parallel data streams to multiple beamformees. These communication modes are respectively referred to as single-user MIMO (SU-MIMO) and MU-MIMO. While IEEE 802.11n only supports SU-MIMO mode, in 802.11ac and above MU-MIMO can be enabled in the DL direction, i.e., at the access point (AP) side (IEEE, “IEEE Standard for Information Technology-Telecommunications and Information Exchange Between Systems Local and Metropolitan Area Network-Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11-2012), 2013). In 802.11ax MU-MIMO can be also enabled in the uplink (UL) (IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 1: Enhancements for High-Efficiency WLAN,” IEEE Std 802.11ax- 2021 (Amendment to IEEE Std 802.11- 2020), 2021).

### B. Compressed Beamforming Feedback

In IEEE 802.11ac/ax, DL MU-MIMO is enabled by the pre-coding and the channel sounding procedures (IEEE, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 4: Enhancements for Very High Throughput for Operation in Bands below 6 GHz,”IEEE Std 802.11ac- 2013 (Amendment to IEEE Std 802.11- 2012), 2013). Pre-coding linearly combines the signals to be simultaneously transmitted to the different beamformees. This procedure shapes the beams focusing the power in the correct directions. The combination weights are antenna-specific and are computed based on channel sounding performed through a NDP, transmitted without beamforming. After receiving the NDP, each beamformee estimates H based on a VHT-LTF for each spatial stream. Next, the beamformee feeds back the matrix to the beamformer in the form of a compressed beamforming feedback, which is computed for each sub-channel k as follows.

Let Hₖ be the M×N sub-matrix of H containing the CFR samples (see Eq. (2)) related to sub-channel k. Hₖ is first decomposed via singular value decomposition (SVD):

Hₖ^{T}=UₖSₖZₖ^{†} (3)

where Uₖ and Zₖ are, respectively, N×N and M×M unitary matrices, while Sₖ is an N×M diagonal matrix collecting the singular values. Next, the first N_{SS}≤N columns of Zₖ are extracted to form the complex-valued beamforming matrix Vₖ that is used by the beamformer to compute the pre-coding weights for the N_{SS} spatial streams directed to the beamformee. Note that the beamformee can be served with at maximum N_{SS}=N spatial streams (see Chapter 13 of (E. Perahia and R. Stacey, Next Generation Wireless LANs: Throughput, Robustness, and Reliability in 802.11n. Cambridge Univ. Press, 2008). Thus, the beamformee is required to send back Vₖ to the beamformer. To do that efficiently, instead of sending the complete matrix, the beamformee derives and transmits its compressed representation. Specifically, the feedback is a number of angles obtained by converting Vₖ into polar coordinates. The transformation is based on the procedure in Method 1, where D_{k,i} and G_{k,l,i} are defined as

$${D}_{k , i} = [ \begin{matrix}{I}_{i - 1} & 0 & & … & 0 \\ 0 & {e}^{j ϕ} \text{?} & 0 & … & ⋮ \\ ⋮ & 0 & ⋱ & 0 & \\ & ⋮ & 0 & {e}^{j ϕ} \text{?} & 0 \\ 0 & … & & 0 & 1\end{matrix} ] , \qquad ( 4 )$$

$${G}_{h , ℓ , i} = [ \begin{matrix}{I}_{i - 1} & 0 & & … & 0 \\ 0 & cos {ψ}_{k , ℓ , i} & 0 & sin {ψ}_{k , ℓ , i} & \\ & 0 & {I}_{ℓ - i - 1} & 0 & ⋮ \\ ⋮ & - sin {ψ}_{k , ℓ , i} & 0 & cos {ψ}_{k , ℓ , i} & 0 \\ 0 & … & & 0 & {I}_{M - ℓ}\end{matrix} ] . \qquad ( 5 )$$

$$\text{?} \text{indicates text missing or illegible when filed}$$

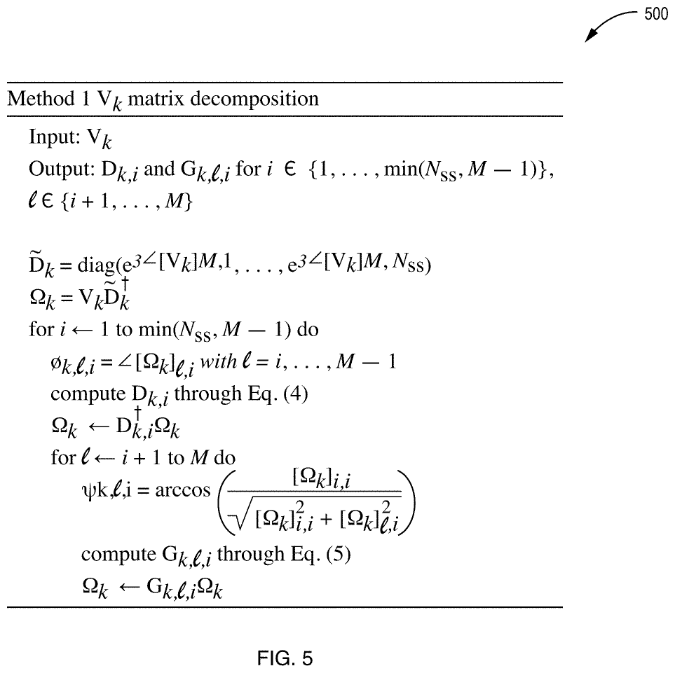

The obtained matrices allows rewriting Vₖ as

$${V}_{k} = {\tilde{V}}_{k} {\tilde{D}}_{k} , \qquad ( 6 )$$

$$with$$

$${\tilde{V}}_{k} = {\prod }_{i = 1}^{min ( {N}_{SS} , M - 1 )} ( {D}_{k , i} {\prod }_{l = i + 1}^{M} {G}_{k , l , i}^{T} ) {I}_{M \times {N}_{SS}} , \qquad ( 7 )$$

where the products represent matrix multiplications. Note that, by construction, the last row of the complex-valued Vₖ matrix, i.e., the feedback for the M-th transmitter antenna, consists of non-negative real numbers. Next, the K×M×N_{SS} beam-forming matrix \tilde{V} is obtained by stacking the \tilde{V}ₖ matrices for k∈{−K/2, . . . , K/2−1}. Thanks to this transformation, the beamformee is only required to transmit the φ and [symbol] angles from which the \tilde{V}ₖ matrices can be reconstructed. The beamforming performance is equivalent at the beamformee when using Vₖ or \tilde{V}ₖ to construct the steering matrix W and, in turn, the feedback for \tilde{D}ₖ is not sent (E. Perahia and R. Stacey, “Next Generation Wireless LANs: Throughput, Robustness, and Reliability in 802.11n,” Cambridge Univ. Press, 2008). An example embodiment of Method 1 is included in FIG. 5, disclosed below.

FIG. 5 is a table 500 with an example embodiment of a Method 1 for Vₖ matrix decomposition.

The angles are quantized for transmission using b_{ϕ}∈{7, 9} bits for ϕ and b_{ψ}−2 bits for ψ. Next, the quantized values are packed into the VHT compressed beamforming frame and transmitted without encryption, thus allowing any device that can access the wireless channel to capture the information sent by the beamformee to the beamformer. The b_{ϕ} and b_{ψ} values can be read in the VHT MIMO control field of the frame, together with other information including the number of columns (N_{SS}) and rows (M) in the beamforming matrix and the channel bandwidth. At the beamformer, the φ and ψ angles are retrieved from their quantized versions

$${q}_{ϕ} = \{ 0 , … , {2}^{b} \text{?} - 1 \} and q \text{?} = \{ 0 , … , {2}^{b} \text{?} - 1 \} using \qquad ( 8 )$$

$$[ ϕ , ψ ] = [ π ( \frac{1}{{2}^{b} \text{?}} + \frac{q \text{?}}{{2}^{b} \text{?}} ) , π ( \frac{1}{{2}^{b} \text{?}} + \frac{q \text{?}}{{2}^{b} \text{?}} ) ]$$

$$\text{?} \text{indicates text missing or illegible when filed}$$

C. DeepCSI Workflow and Learning architecture

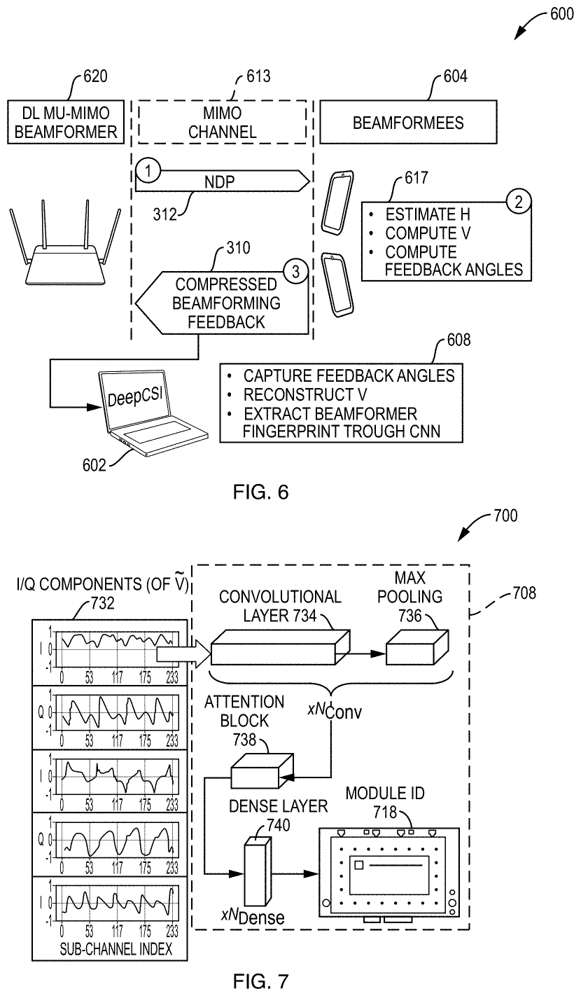

FIG. 6 is a bounce diagram of an example embodiment of DeepCSI workflow 600. In the DeepCSI workflow 600, compressed beamforming feedback 310, computed by any of the beamformees 604 in response to the NDP (e.g., calibration packet) is the final step of the sounding protocol and may be leveraged by DeepCSI to obtain a fingerprint of the beamformer via actions 608 that may be performed by a classifier (not shown) of the system 602.

The DeepCSI workflow 600 summarizes how DeepCSI leverages the sounding protocol mechanism described in Section III-B to obtain a fingerprint of the IEEE 802.11ac/ax AP (beamformer) 620. The sounding is triggered by the beamformer 620 before sending data in the DL MU-MIMO mode to the beamformees 604 via the MIMO channel 613, and concludes with the transmission of the feedback angles computed as part of the computations 617 performed in response to receipt of the NDP 312. DeepCSI exploits the fact that the angles can be easily collected by any Wi-Fi compliant device by setting the Wi-Fi interface in monitor mode and using a network analyzer toolkit, e.g., Wireshark (A. Orebaugh, G. Ramirez, and J. Beale, “Wireshark & Ethereal network protocol analyzer toolkit,” Elsevier, 2006) for non-limiting example, to capture the packet containing the feedback. Notice that DeepCSI does not require the monitor device 602 to be authenticated with the target AP 620. Once the feedback angles are contained, DeepCSI reconstructs \tilde{V} through Eq. (7). Next, the beamforming feedback matrix is used as input for the DNN classifier 708 depicted in FIG. 7 to extract the RFP of the beamformer. Once trained, the DNN can be deployed and utilized in real time for device authentication at the PHY level. The observer can leverage the feedback from any beamformee associated with the target beamformer to compute a beamformer's fingerprint. In turn, DeepCSI is independent of the number of terminals connected to the AP. Moreover, different fingerprints can be obtained for the same beamformer and can be indifferently used to authenticate the device.

FIG. 7 is a block diagram of an example embodiment of a DeepCSI learning method 700. In the example embodiment of FIG. 7, the I and Q components 732 of \tilde{V} serve as input for a neural network classifier, namely the DNN 708, that computes the beamformer fingerprint and returns, as output, the estimated Wi-Fi module ID 718.

The elements of the feedback matrix are fed to the DNN 708 as follows. The I/Q components 732 of the beamforming feedback are stacked into an N_{row}×N_{col}×N_{ch} matrix, where N_{col}≤K identifies the number of selected OFDM subchannels, N_{row}≤N_{SS} and N_{ch}<2M refer to the columns and rows of \tilde{V} used for fingerprinting and the 2-factor is for the I/Q components 732. Note that the feedback for the last transmitting antenna consists of the sole I information as, by construction, the last row of each \tilde{V}ₖ (Eq. (7)) is composed of non-negative real values ([IEEE, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11- 2012), 2013). The learning architecture is inspired from (T. J. O'Shea, T. Roy, and T. C. Clancy, “Over-the-Air Deep Learning Based Radio Signal Classification,” IEEE Journal of Selected Topics in Signal Processing, vol. 12, no. 1, pp. 168- 179, February 2018) and consists of a series of N_{conv} convolutional layers followed by selu activation function (G. Klambauer, T. Unterthiner, A. Mayr, and S. Hochreiter, “Self-Normalizing Neural Networks,” in Proc. of ACM NIPS, 2017), and by a max-pooling layer. The output of the previous block (convolutional layer 734 and max-pooling layer 736) is forwarded through an attention block 738 and—after being flattened—is processed by N_{dense} dense layers 740 with selu activation function. A final dense layer with softmax activation is used for classification. Alpha-dropout layers are interposed between the dense layers. The attention block 738 is inspired by the spatial attention module in (S. Woo, J. Park, J.-Y. Lee, and I. S. Kweon, “CBAM: Convolutional Block Attention Module,” in Proc. of ECCV, 2018). First, the maximum and the average feature maps are obtained by computing respectively the maximum and the mean of the input feature maps over the channel dimension. Next, the two maps are concatenated and forwarded through a convolutional layer with sigmoid activation function that outputs the weights to attend the input feature maps. Specifically, the attention operation consists in multiplying the input by the computed weights. A skip connection is also implemented by summing the output of the attention block with its input before passing the result to the subsequent dense layers. Thanks to the attention block 738, the method 700 learns where the most relevant information is located within the feature maps. This allows the network to focus on the relevant regions obtaining a more effective fingerprint.

A hyper-parameter evaluation was performed as described in Section V, and it was established through experiments that a good set of hyper parameters is N_{conv}=5 with 128 filters each, and N_{dense}=2 dense layers with 128 and 64 neurons each. This architecture yields a DNN containing 489,301 trainable parameters, which is relatively small compared to state-of-the-art DNNs. The DeepCSI learning method 700 is trained in an offline fashion by back propagating the cross-entropy loss between the module identifier (ID) 718 predicted by the classifier and the actual one.

### IV. Experimental Setup

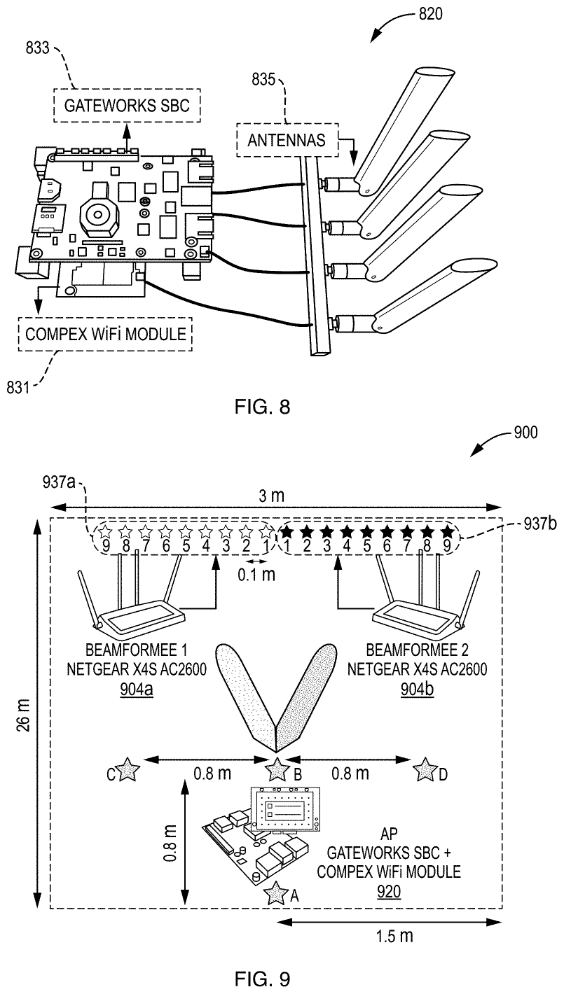

The effectiveness of DeepCSI was evaluated using off-the-shelf devices and through extensive experimental evaluation. To this end, an experimental setup included setting up a Wi-Fi network including one AP (beamformer) and two stations (STAs) (beamformees). The AP was implemented through a Gateworks GW6200 single board computer (SBC) equipped with a Compex WLE 1216v 5-23 IEEE 802.11ac module, as shown in FIG. 8, disclosed below.

FIG. 8 is an image of an example embodiment of a beamformer 820. The beamformer 800 is a DL MU-MIMO enabled Wi-Fi AP. The Compex WLE 1216v5-23 Wi-Fi module 831 was mounted on a Gateworks GW6200 SBC platform 833. Four antennas 835 were connected to the Wi-Fi module 831.

In the experimental setup, two Netgear Nighthawk X4S AC2600 routers, with N∈{1, 2} out of 4 antennas enabled, acted as STAs (beamformees). At the AP, M=3 antennas were used to sound the channel for DL MU-MIMO transmission mode and the STAs were served with N_{SS}∈{1, 2} spatial streams each. Note that implementation specific constraints prevent the use of M=4 for DL MU-MIMO. For the data transmission between the AP and the STAs, channel 42 was used, i.e., f_{c}=5.21 GHz with 80 MHz bandwidth. The number of OFDM sub-channels sounded was K=234 as the mechanism does not consider the 14 control sub-channels and the 8 pilot ones. The AP used the quantization parameters b_{φ}=9 and b_{ψ}=7 for φ and ψ feedback angles, respectively. UDP traffic was generated in the DL direction to induce the AP to trigger the channel sounding mechanism, and the angles (φ, ψ) collected were sent back by the beamformees using the Wireshark network analyzed toolkit (A. Orebaugh, G. Ramirez, and J. Beale, “Wireshark & Ethereal network protocol analyzer toolkit,” Elsevier, 2006) running on an off-the-shelf laptop equipped with an IEEE 802.11ac Wi-Fi card. This allowed retrieving the \tilde{V} matrices associated with each sounding operation, and computing of the beamformer fingerprint (see Section III-C).

Two datasets—namely D1 and D2—were collected. As for the former, the STAs were deployed at different positions as depicted in FIG. 9, disclosed below, to generate different beam patterns and different SNR regimes.

FIG. 9 is a schematic diagram of an example environment of an indoor environment configuration 900. For dataset D1, the position of the AP remains the same for all the acquisitions (star A). The beamformees (904a, 904b) are first placed in front of the AP 920 and next, for each new experiment, beamformees 1 (904a) and 2 (904b) are respectively moved 10 cm to the left and 10 cm to the right. The subsequent positions of the beamformees (904a, 904b) are marked with a first set 937a of stars and second set 937b of stars, respectively, and labeled with a number ∈{1, . . . , 9}. For the dynamic dataset D2, the beamformees (904a, 904b) remain fixed in position 3 while the AP 920 moves following the path described by the stars A-B-C-D-B-A.

The number of enabled antennas was N=2 for each beamformee (904a, 904b) and each of them was served with N_{SS}=2 spatial streams. Dataset D1 allowed evaluation of the performance of DeepCSI in different static conditions. The purpose of dataset D2 was to evaluate the impact of mobility in the beamformer identification. The data were collected while the AP was manually moved following the path described in FIG. 9 by the stars A-B-C-D-B-A, entailing both vertical and horizontal movements. Here, N=N_{SS}=1 for the first beamformee 904a and N=N_{SS}=2 for the second beamformee 904b. The datasets were collected in two different indoor environments reproducing the same configuration depicted in FIG. 9. This allowed evaluating the general applicability of the developed method in recognizing the beamformer in the wild.

The datasets are shared with the community for reproducibility and benchmarking purposes (F. Meneghello, M. Rossi, and F. Restuccia, “DeepCSI—code and datasets,” https://github.com/signetlabdei/DeepCSI, 2022).

### A. Datasets Structure

The datasets include the beamforming feedback angles associated with N_{modules}=10 different Compex Wi-Fi modules, which are the target of the proposed fingerprinting mechanism. They were collected in two indoor environments where the three entities constituting the experimental Wi-Fi network were placed as shown in FIG. 9 and no obstacles are present between the AP 920 and the STAs. At the AP 920, the SBC, the antennas and the coaxial cables remain the same across all the considered network setups, by only changing the Compex Wi-Fi module, that is, the Compex Wi-Fi module 831 of FIG. 8. This ensured that the fingerprint procedure only relied on the hardware imperfections of the Wi-Fi module 831.

With reference to FIG. 9, for the static dataset D1, 9 different measurements were collected for each Compex module by keeping it fixed in position A and changing the positions of the STAs. Specifically, the beamformees (904a, 904b) were first placed in front of the beamformer 920, i.e., with an angle of arrival (AoA) for the direct path of nearly zero degrees, and next moved by multiples of 10 cm respectively to the left and to the right with respect to their initial position (see first set 937a and second set 937b of stars in FIG. 9). The positions of the STAs were maintained fixed for the entire duration of each measurement. These configurations allowed data associated with different beam shaping to be obtained for the ongoing DL MU-MIMO transmissions. Overall, 90 traces, i.e., 9 traces for each of the 10 Compex Wi-Fi modules were collected.

As for the dynamic dataset D2, 11 measurements were collected for each Compex module. Four measurements were collected with the AP 920 fixed in position A. The remaining seven traces are collected while moving the AP 920 following the path described above, i.e., first, the AP 920 is moved 80 cm from position A toward the beamformees reaching position B, next the AP 920 was shifted 80 cm to the left and subsequently 160 cm to the right—up to positions C and D respectively—and finally the AP 920 was brought back in position A passing from B. The beamformees (904a, 904b) were kept fixed in position 3. This dataset allowed evaluation of the performance of DeepCSI in the presence of beamformer mobility. Overall, it included 11 traces for each of the 10 Compex Wi-Fi modules for a total of 110 traces.

Each trace contained the feedback angles sent by the two beamformees during two minutes of transmission. Such feedbacks could be promptly grouped based on the beamformee identifier by applying a filter on the packets' source address.

### B. DeepCSI Training and Testing Procedure

The DeepCSI classifier (see FIG. 7) was trained using different PHY configurations, to evaluate its robustness in correctly identifying the beamformer device (the AP) as the position of the beamformees change—dataset D1—and when the beamformer moves within the environment —dataset D2.

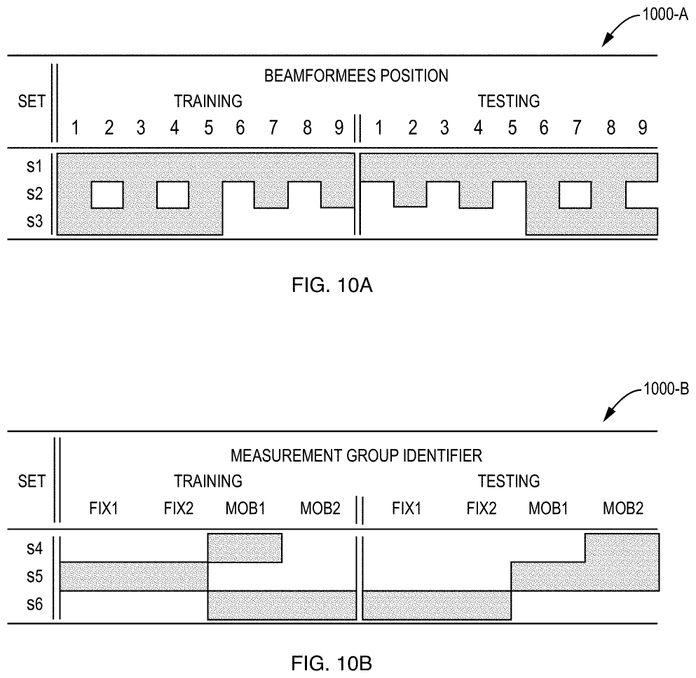

FIG. 10A is a table 1000-A that summarizes an example embodiment of different training/testing sets for dataset D1 to assess the DeepCSI performance when varying the beamformees positions. The table 1000-A summarizes the different training/testing sets that were considered for dataset D1, where the beamformees positions {1, . . . , 9} are depicted in FIG. 9, disclosed above. When the same positions are considered in the training and testing phase, the first 80% of the collected data is used for training and validating the model, while the remaining 20% serves as test data. In all cases, the last 20% of training data was used for model validation. As part of the evaluation, the performance of DeepCSI was assessed on \tilde{V} sub-matrices. This made it possible to evaluate the impact of using (i) different groups of transmitter antennas and spatial streams, and (ii) different portions of the radio spectrum. For (i), we vary N_{ch} and N_{row}. For (ii), we pick a subset of the K available sub-channels. The training/test sets considered for dataset D2 are detailed in the table 1000-B of FIG. 10B.

FIG. 10B is a table 1000-B that summarizes an example embodiment of different training/testing sets for dataset D2. For ease of readability, the eleven traces composing the dataset into were combined into four groups. ‘Fix 1’ and ‘fix 2’ collect the four traces—two traces each—acquired keeping fixed the position of the AP. The mobility traces—i.e., collected while the AP is manually moved in the environment—are grouped in ‘mob 1’ and ‘mob 2’, where the first group contains four measurements, while the remaining three traces compose the second group. As such, ‘Fix 1’ and ‘fix 2’ group two static traces each, i.e., the AP is fixed in position A (see FIG. 9). ‘Mob 1’ and ‘mob 2’ contain, respectively, four and three mobility traces, i.e., collected while the AP is manually moved following the path detailed in FIG. 9, disclosed above.

Note that the mobility traces encode variations associated with the manual movement of the AP. This implies that the positions taken by the AP during the acquisition of the traces are approximately the same due to slight variations in the movements. Moreover, a person is always present in the proximity of the AP to perform the operation, introducing additional variability.

For each configuration, DeepCSI was independently trained on the feedbacks from the two beamformees, obtaining one model for each of them. In this way, a realistic usage scenario was evaluated where each beamformee authenticated the beamformer based on local information, without relying on some other, possibly malicious, entities. The results considering both the beamformees are also reported for completeness.

### V. Experimental Results

DeepCSI was experimentally evaluated on the Wi-Fi network setups of table 1000-A and table 1000-B of FIG. 10A and FIG. 10B, respectively, assessing the effectiveness of the extracted beamformer fingerprint for different beamformer and beamformees configurations. First, the DNN hyper parameters selection process is briefly discussed and then the DeepCSI performance is presented by varying the PHY parameters of the MU-MIMO transmission mode. In the first part, the DeepCSI performance is assessed on dataset D1, evaluating the effect of the beamformees' positions. Dataset D2 is considered in the second part to analyze the impact of the beamformer mobility on the device identification accuracy.

DeepCSI hyper parameters selection

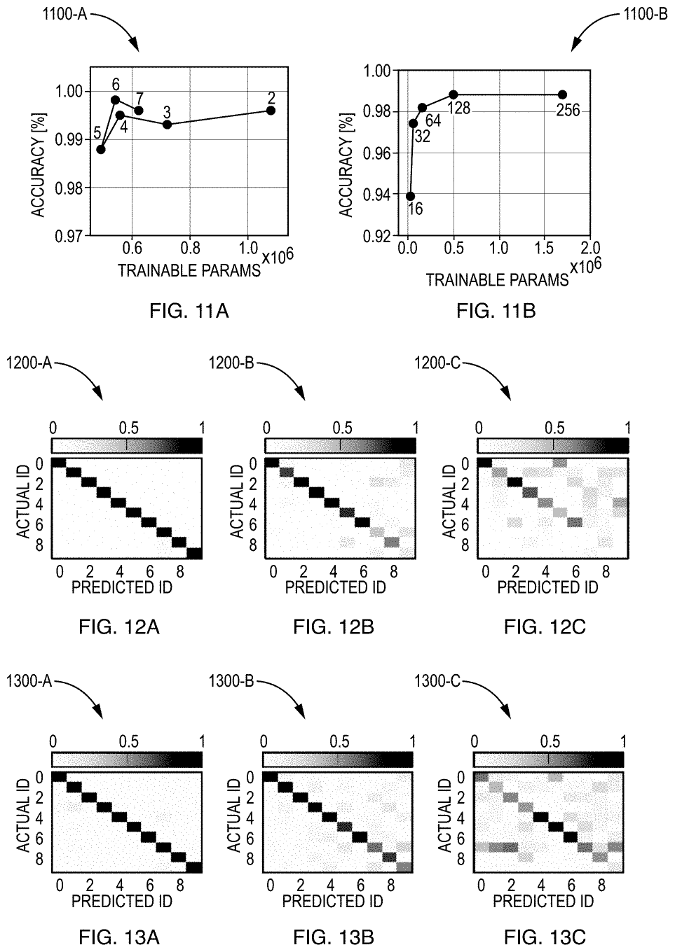

FIG. 11A and FIG. 11B describe the DeepCSI accuracy for beamformer 1, on S1 validation data, by varying the DNN parameters, as disclosed below.

FIG. 11A is plot 1100-A of an example embodiment of DeepCSI accuracy by varying the number of convolutional layers, with 128 filters each, from 2 to 7.

FIG. 11B is plot 1100-B of an example embodiment of DeepCSI accuracy by using 5 convolutional layers and varying the number of filters in each layer, from 16 to 256. FIG. 11A and FIG. 11B respectively evaluate the effect of tuning the number of convolutional layers and filters for the DNN presented in Section III-C. Noticeably, the accuracy remains almost constant when varying the number of layers. Also, the accuracy increases with an increasing number of filters, at a cost of a higher network complexity (i.e., more trainable parameters). As a trade-off between accuracy and complexity, N_{conv}=5 convolutional layers were selected with 128 filters each and kernel sizes of (1, 7) for the first three layers, (1,5) for the fourth and (1,3) for the last one by using the elbow method (D. J. ketchen and C. L. Shook, “The Application of Cluster Analysis in Strategic Management: an Analysis and Critique,” Strategic Management Journal, vol. 17, pp. 441-458, 1996). The max-pooling kernels were set to (1, 2) and the alpha-dropout between the three dense layers was applied with retain probability of 0.5 and 0.2, respectively.

DeepCSI performance using different beamformees configurations.

FIGS. 12A-C are plots of respective embodiments of results that show the accuracy of DeepCSI in correctly identifying a beamformer among 10 Compex Wi-Fi modules in a dataset, as disclosed below.

FIG. 12A is a plot 1200-A that shows the accuracy for the S1 set is 98.02%.

FIG. 12B is a plot 1200-B that shows the accuracy for the S2 set is 75.41%.

FIG. 12C is a plot 1200-C that shows the accuracy for the S3 set is 42.97%. The plots 1200-A, 1200-B, and 1200-C show confusion matrices for beamformee 1, 3 TX antennas, and spatial stream 0. The ID in the plots refers to the AP Wi-Fi module identifier. The results were obtained using the beamforming feedback angles from a single beamformee. The confusion matrices are reported for each of the three training/testing configurations in table 1000-A of FIG. 10A, where ID refers to the AP module identifier. It was observed from the plots that the accuracy increases with more spatial diversity in the training data, reaching 98.02% when all the configurations are used at training time (see FIG. 12A for set S1). With sets S2 (see FIG. 12B) and S3 (see FIG. 12C), the beamformee positions at training and testing times differ. The lowest accuracy is obtained with S3 (worst-case configuration) as shown in FIG. 12C. This is because S3 is the set with the largest difference between training and testing positions. The performance improves when going from S3 to S2, as the latter provides DeepCSI with a more balanced set of positions during training, allowing the classifier to fill the knowledge gaps by “interpolating” the patterns learned from adjacent positions. The network reuses information from similar beam patterns leading to an identification accuracy of 75%, even when the beamformee is at a position that was not contained in the training set (see FIG. 12B). The same applies to FIGS. 13A-C, disclosed below, where the beamforming feedback angles of both beamformees are used to build the training set. This allows to slightly increase the DeepCSI accuracy on sets S2 and S3. However, using this technique in real-world scenarios poses security concerns associated with the reciprocal trustworthiness of the beamformees in a Wi-Fi network.

FIGS. 13A-C are plots of example embodiments of confusion matrices for mixed beamformees, 3 TX antennas, and spatial stream 0. The ID in the plots refers to the AP Wi-Fi module identifier.

FIG. 13A is a plot 1300-A that shows the accuracy for the S1 set is 97.62%.

FIG. 13B is a plot 1300-B that shows the accuracy for the S2 set is 77.38%.

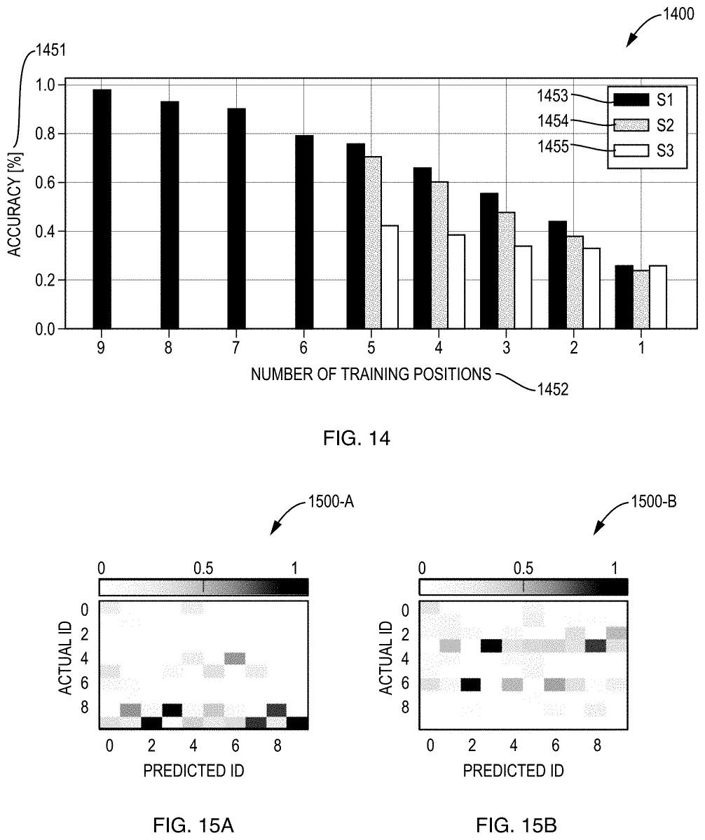

FIG. 13C is a plot 1300-C that shows the accuracy for the S3 set is 47.28%. The impact of the number of beamformee training positions is evaluated in FIG. 14, disclosed below.

FIG. 14 is a chart 1400 of an example embodiment of DeepCSI accuracy 1451 by varying the number of training positions 1452 from the considered set (see FIG. 10A, table 1000-A). In the example embodiment of FIG. 14, Set S1 1453 is trained on a maximum of 9 beamformee positions while S2 1454 and S3 1455 on 5. The accuracy 1451 reported is obtained by increasing the number of positions used at training time from 1 to 9 for set S1 and from 1 to 5 for sets S2 and S3, according to table 1000-A of FIG. 10A. In all the cases, the accuracy 1451 increases with more beamformee positions in the training data, which confirms that the fingerprint is more effective when high spatial diversity is present in the training data. In FIG. 15A and FIG. 15B, the effect of swapping the beamformees used at training and testing times is evaluated for the same network configuration.

FIGS. 15A and 15B are plots of example embodiments of confusion matrices for set S1, training on one beamformee and testing on the other, with 3 TX antennas and spatial stream 0. FIG. 15A is a plot 1500-A of an example embodiment of a confusion matrix for training on beamformee 1 and testing on beamformee 2, in which the accuracy is 25.86%. FIG. 15B is a plot 1500-B of an example embodiment of a confusion matrix for training on beamformee 2 and testing on beamformee 1, in which the accuracy is 25.02%. The ID in the plots refers to the AP Wi-Fi module identifier. DeepCSI was trained with data from a given beamformee and the trained DNN model was used to identify the AP module from the \tilde{V} matrices computed by a different beamformee (for the same AP module). The learned fingerprint in this case performs poorly as matrix \tilde{V} captures hardware inaccuracies of both devices, i.e., the beamformer (the AP) and the beamformee. While a well-designed learning architecture can identify with high accuracy the beamformer when the beamformee remains the same at training and testing times, it hardly succeeds when these devices differ. It is understood that in a real-world scenario the impact of this will be even stronger, as the beamformees can be from different vendors and have different hardware configurations.

DeepCSI performance when varying the beamformer transmission parameters.

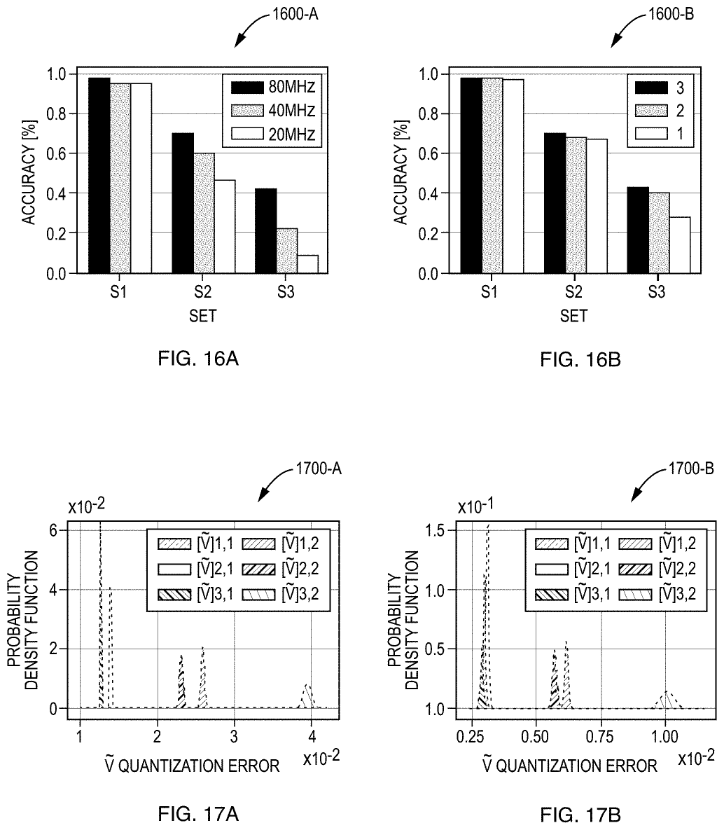

FIGS. 16A and 16B are charts of example embodiment of DeepCSI accuracy by varying the channel bandwidth and the number of transmitter antennas, using spatial stream 0.

FIG. 16A is a chart 1600-A of an example embodiment of DeepCSI accuracy obtained by varying the channel bandwidth, i.e., selecting respectively Ncol=234, 110, 54, out of the K=234 OFDM sub-channels. In FIG. 16A, the accuracy of DeepCSI is compared when considering different portions of the radio spectrum. According to the IEEE 802.11ac OFDM channels specifications (IEEE, “IEEE Standard for Information Technology—Telecommunications and Information Exchange Between Systems Local and Metropolitan Area Networks- Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11-2012), 2013), from the 234 sub-channels on an 80 MHz channel, we can group sub-channels belonging to two 40 MHz and four 20 MHz channels. Therefore, from the data collected on the IEEE channel 42 at 80 MHz, 110 sub-channels were extracted for the 40 MHz channel 38 and 54 sub-channels for the 20 MHz channel 36, and the performance of DeepCSI on these subsets was assessed. These results prove that the accuracy increases with a larger bandwidth, especially when considering the most challenging configurations S2 and S3.

FIG. 16B is a chart 1600-B of an example embodiment of DeepCSI accuracy by varying the number of transmitter antennas, i.e., selecting respectively N_{ch}=3, 2, 1 rows of the beamforming feedback matrix \tilde{V}. FIG. 16B evaluates the impact of increasing from 1 to 3 the number of transmitter antennas used to compute the fingerprint. Note that the accuracy mainly depends on the number of selected antennas and only weakly depends on their IDs. Thus, only results for a single selection pattern out of the possible ones is shown for each number of antennas. The DeepCSI performance remains almost constant on set Si, while the accuracy increases on S2 and S3 going from 1 to 3 transmitter antennas. These results confirm that exploiting to the maximum extent the spatial diversity at the beamformer—by considering all the OFDM sub-channels and transmitter antennas—is key to designing robust RFP methods.

DeepCSI performance when changing the reference beamformee spatial stream.

To evaluate the effect of changing the DNN input spatial stream on the beamformer fingerprinting accuracy, we consider the impact of the beamforming feedback angles quantization on the columns of \tilde{V}, representing the spatial streams dimensions. From Method 1 disclosed in the table 500 of FIG. 5, it follows that the impact of the quantization error increases going from the first to the last reconstructed stream. This fact was verified by simulating an OFDM MU-MIMO channel, considering the ray tracing model of (IEEE, “TGac Channel Model Addendum. Version 12. IEEE 802.11- 09/0308r 12,” 2010). The channel matrix H was obtained for 100,000 transmissions in MU-MIMO mode, and derived via SVD. Hence, we the q_{φ}, and q_{ψ} quantized angles were computed following Method 1 (see FIG. 5) and using the quantization parameters defined in the standards (IEEE, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 4: Enhancements for Very High Throughput for Operation in Bands below 6 GHz,” IEEE Std 802.11ac-2013 (Amendment to IEEE Std 802.11-2012), 2013, “IEEE Standard for Information Technology-Telecommunications and Information Exchange Between Systems Local and Metropolitan Area Networks-Specific Requirements Part 11: Wireless LAN Medium Access Control (MAC) and Physical Layer (PHY) Specifications Amendment 1: Enhancements for High-Efficiency WLAN,” IEEE Std 802.11ax-2021 (Amendment to IEEE Std 802.11-2020), 2021). These operations are the same performed by the beamformees to generate the feedback. Next, \tilde{V} was reconstructed from the quantized angles and the reconstruction error was evaluated on each combination of transmitter antennas and spatial streams. The probability density functions (PDFs) of the quantization error were plotted in FIGS. 17A and 17B using (b_{ψ}=5, b_{φ}=7) and (b_{ψ}=7, b_{ψ}=9) bits for quantization.

FIGS. 17A and 17B are plots 1700-A and 1700-B, respectively, of example embodiments of the probability density function (PDF) of the \tilde{V} quantization error using the two standard-compliant sets of values for the beamforming feedback angles quantization bits. It was noticed that the reconstruction of the second column of \tilde{V}, i.e., the second stream, is less accurate than the reconstruction of the first, for all the three transmitter antennas. This is intrinsically related to the construction of the D_{k,i} and G_{k,l,i} matrices from the quantized angles, and to their combination for the computation of \tilde{V} (see Eq. (7)). Indeed, the method has a recursive structure by which the quantization error on the first stream propagates to the next ones, leading to worse approximations for the higher order columns of matrix \tilde{V}. The quantization error can also be visualized from the empirical measurements.

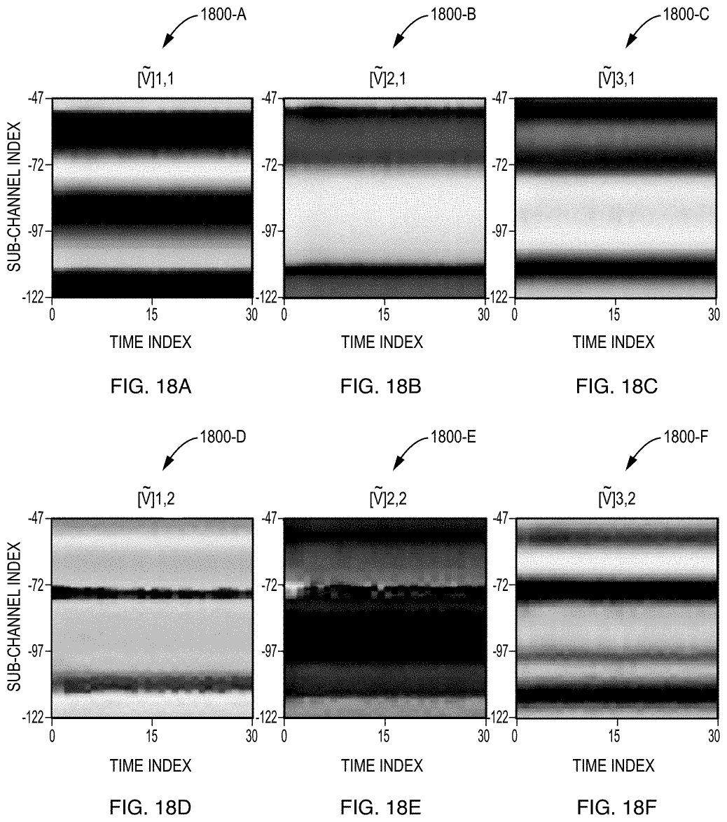

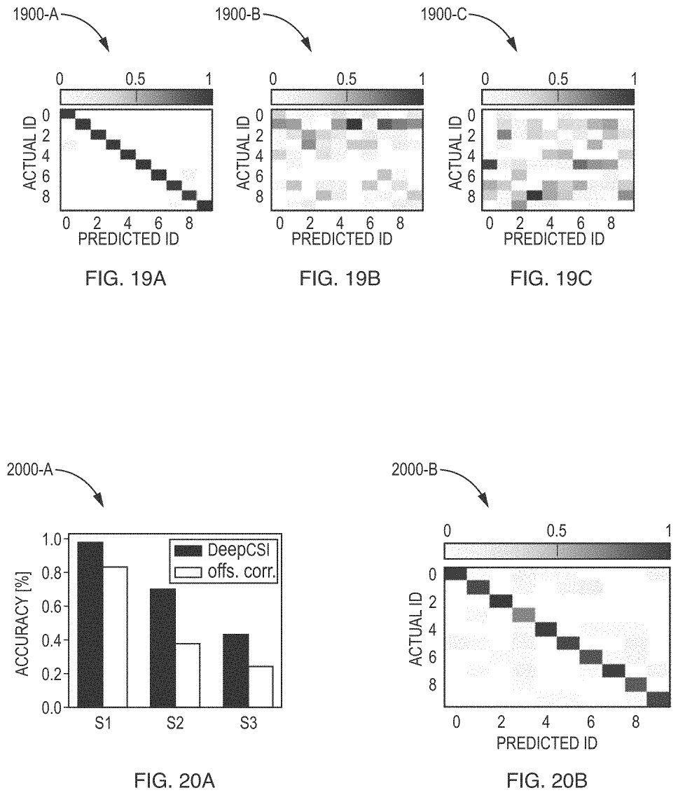

FIGS. 18A-F are plots 1800-A, 1800-B, 1800-C, 1800-D, 1800-E, and 1800F, respectively, of time evolution of \tilde{V} for the first 75 OFDM sub-channels, in static conditions. The columns refer to the transmit antennas while the rows to the spatial streams. In FIGS. 18A-F, an excerpt of the \tilde{V} matrix reconstructed by DeepCSI from the quantized angles obtained at the beamformee side in static conditions is plotted. The quantization error is clearly visible for the second spatial stream (column 2 of matrix \tilde{V}). Thus, the performance of DeepCSI decreases when considering as DNN input the data associated with the second spatial stream (FIGS. 19A-C) instead of the first one (FIGS. 11A-B). While on set S1 the beamformer can still be identified with high accuracy using data from the second spatial stream, when considering sets S2 and S3—thus reducing the number of training positions—the beamformer fingerprint can no longer be effectively extracted, leading to a considerable drop in the classification accuracy.

FIGS. 19A-C are plots, namely 100-A, 1900-B, and 1900-C, respectively, of example embodiments of confusion matrices with beamformee 1, 3 TX antennas, and spatial stream 1. The ID in the plots refers to the AP Wi-Fi module identifier.

DeepCSI performance compared with learning from a processed input.

DeepCSI learns beamformer-specific features directly from the I/Q samples of matrix \tilde{V}. As an alternative approach, the effect of pre-processing such I/Q data before using it as input for the DNN was evaluated. Specifically, the beamforming feedback matrices was applied to the data cleaning method presented in (F. Meneghello, D. Garlisi, N. Dal Fabbro, I. Tinnirello, and M. Rossi, “Environment and Person Independent Activity Recognition with a Commodity IEEE 802.11ac Access Point,” arXiv preprint arXiv: 2103.09924, 2021). The CFR estimated at the beamformee on the NDP—and from which \tilde{V} is derived—slightly deviates from the theoretical model in Eq. (2) due to hardware imperfections causing undesired phase offsets (H. Zhu, Y. Zhuo, Q. Liu, and S. Chang, “π-Splicer: Perceiving Accurate CSI Phases with Commodity WiFi Devices,” IEEE Transactions on Mobile Computing, vol. 17, no. 9, pp. 2155-2165, 2018). Among these imperfections, the most significant are: (i) the carrier frequency offset (CFO), which originates from the difference between the carrier frequency at transmitter and receiver sides; (ii) the sampling frequency offset (SFO), which is due to clocks synchronization error; (iii) the packet detection delay (PDD), i.e., the receiver decoding time; (iv) the phase-locked loop offset (PPO), which is associated with the random generation of the initial signal phase by the phase-locked loop module; and (v) the phase ambiguity (PA), which accounts for the phase difference (multiples of a) among the signals at the transmitter antennas. By considering these contributions, the overall phase offset, θ_{offs,k,m,n}, can be formulated as

θ_{offs,k,m,n}=θ_{CFO}−2πk(τ_{SFO}+τ_{PDD})/T+θ_{PPO}+θ_{PA} , (9)

and, in turn, the CFR estimated at the beamformee during the channel sounding procedure becomes

Ĥ_{k,m,n}=H_{k,m,n}e^{jθ}^{_{offs,k,m,n}}. (10)

Besides the PDD, all the other contributions to Eq. (9) are associated with imperfections at the transmitter device, which is the target of the fingerprinting technique, i.e., the AP. An intuition is that the beamforming feedback matrix \tilde{V}—derived from H as discussed in Section III-B—would be affected by the phase offsets (i)-(v). Thus, the offsets cleaning method of (F. Meneghello, D. Garlisi, N. Dal Fabbro, I. Tinnirello, and M. Rossi, “Environment and Person Independent Activity Recognition with a Commodity IEEE 802.11ac Access Point,” arXiv preprint arXiv: 2103.09924, 2021) may be used to improve its quality. Along this line of reasoning, FIGS. 20A and 20B evaluate the impact of a preliminary offset cleaning phase on matrix \tilde{V} on the fingerprinting accuracy. DeepCSI (with no offsets cleaning) outperforms its version with the described offset correction capability across all the training/testing sets. In other words, the offsets introduced by the beamformer hardware imperfections are strategic to reliably recognize the device, and any offset cleaning may result in their partial removal, affecting the fingerprinting quality.

FIGS. 20A-B show a comparison with the accuracy obtained by learning the fingerprints from the processed version of \tilde{V}, i.e., after applying the offsets correction (offs. corr.) in (F. Meneghello, D. Garlisi, N. Dal Fabbro, I. Tinnirello, and M. Rossi, “Environment and Person Independent Activity Recognition with a Commodity IEEE 802.11ac Access Point,” arXiv preprint arXiv: 2103.09924, 2021) using beamformee 1, 3 TX antennas, and spatial stream 0. FIG. 20A is a chart 2000-A of an example embodiment of DeepCSI accuracy compared with the one obtained using the processed input. FIG. 20B is a plot of an example embodiment of a confusion matrix for 51 after offset correction. The accuracy: 83.10%.

DeepCSI performance in the presence of beamformer mobility.

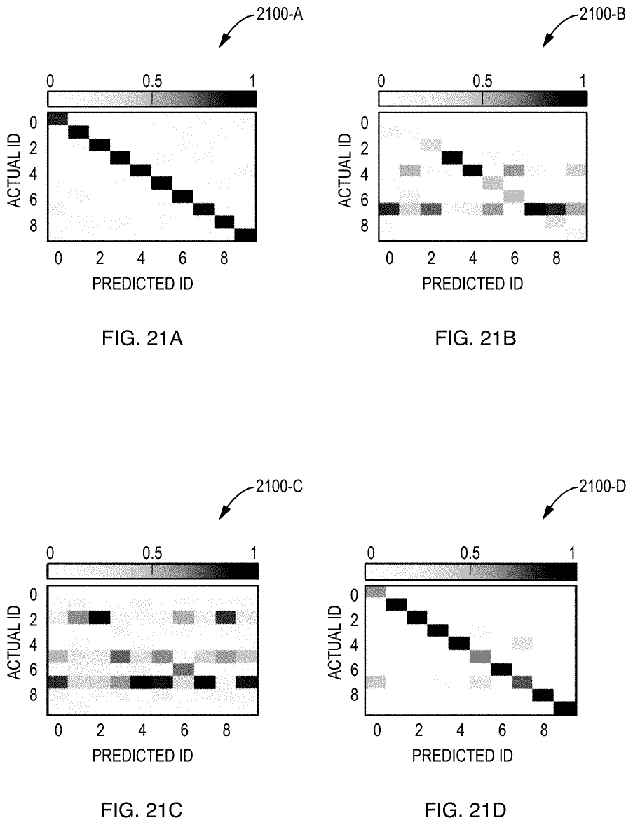

FIGS. 21A-D are example embodiments of plots 2100-A, 2100-B, 2100-C, and 2100-D, respectively, of confusion matrices with beamformee 1, 3 TX antennas, and spatial stream 0. The plot 2100-A of FIG. 21A is for S4, with training and testing on the complete AP mobility path. The accuracy is 82.56%. The plot 2100-B of FIG. 21B is for S4 with training and testing on different AP mobility sub-paths. The accuracy is 41.15%. The plot 2100-C of FIG. 21C is for S5 with training on static conditions and test on mobility traces. The accuracy is 20.50%. The plot 2100-D of FIG. 21D is for S6 with training on mobility traces and test on static conditions. The accuracy is 88.12%.

The robustness of DeepCSI on beamformer's mobility is evaluated through dataset D2. In FIGS. 21A and 21B the performance of DeepCSI on set S4 (see FIG. 10B, table 1000-B) is reported. Specifically, in FIG. 21A, the entire mobility path for both the training and testing sets is considered. It should be reminded that even if the theoretical path is the same for all the measurements, the operation is performed manually and, in turn, the actual shifts undergo uncontrolled variations that reflect on the collected traces. The results show that DeepCSI is able to effectively learn a fingerprint of the AP from the MU-MIMO beamforming feedback matrices even when the AP moves, reaching an accuracy above 80%. The proposed learning architecture allows compensating for the slight variations introduced by the manual shifts of the AP and the presence of the person moving in the vicinity. The fingerprint is less effective when the environmental conditions sharply depart from the training ones. The high-scale modifications on the beamforming feedback matrices—associated with the channel variations—prevent the neural network from effectively capturing the small-scale variations that descend from the hardware imperfections. Such behavior is shown in FIG. 21B, where DeepCSI is trained and tested in different mobility conditions. The training and validation phases are performed on the first half of the traces in ‘mob1’, i.e., the portions related to the sub-path A-B-C-B. The test is executed on the fraction of the traces in ‘mob 2’ collected while the AP spans the segments B-D-B. Overall, the results in FIG. 21A and FIG. 21B indicate that the higher the variability in the training set, the more likely DeepCSI will learn fingerprints that are robust to changing radio channel conditions. The variability in the training set allows the learning method to properly detect the elements that are in common to the traces and, in turn, identify the hardware-related features. In FIG. 21C and FIG. 21D, the performance of DeepCSI on sets S5 and S6 is reported. When DeepCSI is trained on the sole static traces—set S5—the learned fingerprint is not effective in recognizing the beamformer when it moves in the environment. On the other hand, once trained on the dynamic traces, DeepCSI is able to correctly identify the AP in static conditions (about 88% of accuracy on set S6). These last results confirm that the diversity in the training set is desirable to obtain a robust method able to generalize over different conditions.

Disclosed herein are example embodiments of a novel approach to Wi-Fi radio fingerprinting (RFP) which leverages IEEE 802.11-compliant steering matrices to authenticate Wi-Fi devices. Such disclosure enables the following key advances:

For the first time, the feasibility of RFP for MU-MIMO Wi-Fi is demonstrated. To this end, DeepCSI leverages the beamforming feedback matrices computed by any of the beamformees and transmitted in clear (non-encrypted) to the beamformer. Results disclosed herein verify that the matrices are affected by the beamformer hardware imperfections and, in turn, can be used to identify the device. Moreover, the feedback is not affected by inter-stream and inter-user interference, thus, increasing robustness. DeepCSI is independent of the number of beamformees associated with the target beamformer: different beamformer's fingerprints can be computed, one from each beamformee. Conversely from prior work, DeepCSI does not require direct CSI computation and, in turn, can be run on any Wi-Fi device without requiring SDRs.

A massive data collection campaign was performed with off-the-shelf Wi-Fi equipment, where 10 Wi-Fi radios emit MU-MIMO signals in different positions. Experimental results indicate that DeepCSI is able to correctly identify the transmitter with accuracy above 98%. We have evaluated DeepCSI fingerprinting accuracy by differentiating the set of positions for the devices at training and testing times. An example embodiment of a technique disclosed herein achieves accuracy of 73% when training is performed on a more balanced set of spatial points, which allows the classifier to interpolate the training patterns for the missing points, using those from adjacent training positions.

For the first time, the proposed RFP technique is evaluated with moving Wi-Fi devices. DeepCSI reaches an accuracy above 82%, showing the robustness of the learned fingerprint to changing radio channel conditions. Results disclosed herein show that the higher the variability in the traffic traces used for the training phase, the higher is the accuracy when the method is used at run-time to identify the devices. This indicates the need for extensive datasets to train effective RFP methods. In this vision, the datasets are shared (F. Meneghello, M. Rossi, and F. Restuccia, “DeepCSI—code and datasets,” https://github.com/signetlabdei/DeepCSI, 2022).

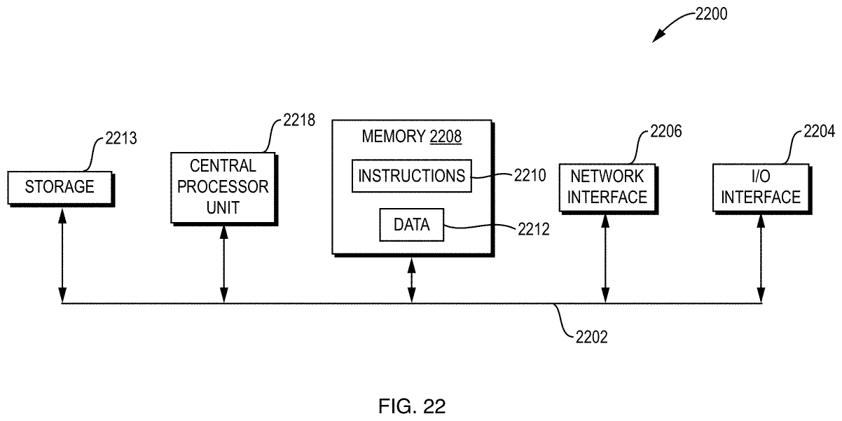

FIG. 22 is a block diagram of an example of an internal structure of a computer 2200 in which various embodiments of the present disclosure may be implemented. The computer 2200 contains a system bus 2202, where a bus is a set of hardware lines used for data transfer among the components of a computer or digital processing system. The system bus 2202 is essentially a shared conduit that connects different elements of a computer system (e.g., processor, disk storage, memory, input/output ports, network ports, etc.) that enables the transfer of information between the elements. Coupled to the system bus 2202 is an I/O device interface 2204 for connecting various input and output devices (e.g., keyboard, mouse, display monitors, printers, speakers, microphone, etc.) to the computer 2200. A network interface 2206 allows the computer 2200 to connect to various other devices attached to a network (e.g., global computer network, wide area network, local area network, etc.). Memory 2208 provides volatile or non-volatile storage for computer software instructions 2210 and data 2212 that may be used to implement embodiments (e.g., method 200) of the present disclosure, where the volatile and non-volatile memories are examples of non-transitory media. Disk storage 2213 also provides non-volatile storage for the computer software instructions 2210 and data 2212 that may be used to implement embodiments (e.g., method 200) of the present disclosure. A central processor unit 2218 is also coupled to the system bus 2202 and provides for the execution of computer instructions.

Further example embodiments disclosed herein may be configured using a computer program product; for example, controls may be programmed in software for implementing example embodiments. Further example embodiments may include a non-transitory computer-readable-medium that contains instructions that may be executed by a processor, and, when loaded and executed, cause the processor to complete methods and techniques described herein. It should be understood that elements of the block and flow diagrams may be implemented in software or hardware, such as via one or more arrangements of the circuitry of FIG. 22, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random-access memory (RAM), read only memory (ROM), compact disk read-only only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for identifying a remote device, the method comprising:
capturing a channel state information (CSI) packet, sent from a receiver device in response to receiving a calibration packet, the calibration packet sent by the remote device via transmitter hardware;
extracting a feature set from the CSI packet captured, the feature set affected by characteristics of the transmitter hardware;
producing a classified feature set by classifying the feature set extracted; and
determining an identifier based on the classified feature set, the identifier corresponding to the remote device.

2. The method of claim 1, wherein the CSI packet is a non-encrypted packet and wherein the CSI packet is a multi-user multi-input, multi-output (MU-MIMO) CSI packet.

3. The method of claim 1, wherein the characteristics represent at least one imperfection of the transmitter hardware of the remote device.

4. The method of claim 1, wherein the remote device is among a plurality of remote devices and wherein the identifier determined includes a) a unique device identifier, the unique device identifier distinguishing the remote device from the plurality of remote devices and b) a probability that the remote device sent the CSI packet.

5. The method of claim 1, wherein the calibration packet is sent from a beamformer to a beamformee, wherein the CSI packet represents beamforming feedback information, and wherein the method further comprises capturing the CSI packet by monitoring a wireless channel between the beamformer and the beamformee.

6. The method of claim 5, wherein the feature set extracted includes beamforming feedback matrices computed by the beamformee, wherein the classifying is based on beamforming feedback angles, and wherein the beamforming feedback angles are derived from the beamforming feedback matrices.

7. The method of claim 1, wherein the classifying includes employing a machine learning model to produce the classified feature set.

8. The method of claim 1, wherein the CSI packet includes physical layer (PHY) level information and wherein the classifying includes demodulating the PHY-level information and processing, via the machine learning model, the PHY-level information demodulated.

9. The method of claim 1, wherein the remote device is wireless device and wherein the wireless device is Wi-Fi compliant.

10. The method of claim 1, further comprising employing the identifier to authenticate the remote device or outputting the identifier to a system, the system configured to authenticate the remote device based on the identifier output.

11. A system for identifying a remote device, the system comprising:
a transceiver configured to capture a channel state information (CSI) packet, sent from a receiver device in response to receiving a calibration packet, the calibration packet sent by the remote device via transmitter hardware; and
a classifier configured to (i) extract a feature set from the CSI packet captured, the feature set affected by characteristics of the transmitter hardware and (ii) produce a classified feature set by classifying the feature set extracted, the classifier further configured to determine an identifier based on the classified feature set, the identifier corresponding to the remote device.

12. The system of claim 10, wherein the CSI packet is a non-encrypted packet and wherein the CSI packet is a multi-user multi-input, multi-output (MU-MIMO) CSI packet.

13. The system of claim 10, wherein the characteristics include at least one imperfection of the transmitter hardware of the remote device.

14. The system of claim 10, wherein the remote device is among a plurality of remote devices and wherein the identifier determined includes a) a unique device identifier, the unique device identifier distinguishing the remote device from the plurality of remote devices and b) a probability that the remote device sent the CSI packet.

15. The system of claim 10, wherein the calibration packet is sent from a beamformer to a beamformee, wherein the CSI packet represents beamforming feedback information, and wherein the transceiver is further configured to capture the CSI packet by monitoring a wireless channel between the beamformer and the beamformee.

16. The system of claim 15, wherein the feature set extracted includes beamforming feedback matrices computed by the beamformee, wherein the classifying is based on beamforming feedback angles, and wherein the beamforming feedback angles are derived from the beamforming feedback matrices.

17. The system of claim 10, wherein the classifier is further configured to employ a machine learning model to produce the classified feature set, wherein the CSI packet includes physical layer (PHY) level information, and wherein the classifier is further configured to demodulate the PHY-level information and process, via the machine learning model, the PHY-level information demodulated

18. The system of claim 10, wherein the remote device is a wireless device and wherein the wireless device is Wi-Fi compliant.

19. The system of claim 10, further comprising a controller and wherein the controller is configured to employ the identifier to authenticate the remote device or output the identifier to an other system, the other system configured to authenticate the remote device based on the identifier output.

20. A non-transitory computer-readable medium for identifying a remote device, the non-transitory computer-readable medium having encoded thereon a sequence of instructions which, when loaded and executed by at least one processor, causes the at least one processor to:
capture a channel state information (CSI) packet, sent from a receiver device in response to receiving a calibration packet, the calibration packet sent by the remote device via transmitter hardware;
extract a feature set from the CSI packet captured, the feature set affected by characteristics of the transmitter hardware;
produce a classified feature set by classifying the feature set extracted; and
determine an identifier based on the classified feature set, the identifier corresponding to the remote device.
